(19) United States
(12) Patent Application Publication
(10) Pub. No.: US 2015/0113379 A1
(43) Pub. Date: Apr. 23, 2015

(54) REPRESENTATION OF UNSTRUCTURED GRIDS

(71) Applicant: SCHLUMBERGER TECHNOLOGY CORPORATION, Sugar Land, TX (US)

(72) Inventors: Mark Wakefield, Abingdon (GB); Richard Asbury, Abingdon (GB)

(21) Appl. No.: 14/520,716

(22) Filed: Oct. 22, 2014

Related U.S. Application Data
(60) Provisional application No. 61/894,460, filed on Oct. 23, 2013.

(51) Int. Cl. G06F 17/24

(52) U.S. Cl. CPC G06F 17/245
USPC 715/227

(57) ABSTRACT

A method can include receiving an unstructured grid of a multi-dimensional region; partitioning at least a portion of the unstructured grid into subdomains based at least in part on a cell number criterion; generating a hierarchical representation of the at least a portion of the unstructured grid that includes the subdomains and the cells; indexing cells in the subdomains based at least in part on the cell number criterion to define a data structure; and assigning respective property values to respective indexed cells for at least a portion of the data structure.

### RELATED APPLICATIONS

This application claims priority to and the benefit of U.S. Provisional Patent Application No. 61/894,460, filed 23 Oct. 2013, which is incorporated by reference herein.

### BACKGROUND

Data associated with a geologic environment, which may be measured data, processed data, simulation results, etc., may be provided in a structured form. For example, data may be provided in a multi-dimensional array format (e.g., as stored in memory of a data storage device or system). Where such data is rendered to a display, the data may be at a resolution that corresponds to the resolution of the array format. For example, a two-dimensional array or a slice of a three-dimensional array may be rendered as a pixel image to a display, which may appear pixelated. Further, as an array may be quite large, processing of the data therein may take considerable time. For visualization of data, rendering directly from mathematical array structures to corresponding image pixels may be sub-optimal, for example, in terms of conveyance of information and timeliness (e.g., computational demands).

### SUMMARY

A method can include receiving an unstructured grid of a multi-dimensional region; partitioning at least a portion of the unstructured grid into subdomains based at least in part on a cell number criterion; generating a hierarchical representation of the at least a portion of the unstructured grid that includes the subdomains and the cells; indexing cells in the subdomains based at least in part on the cell number criterion to define a data structure; and assigning respective property values to respective indexed cells for at least a portion of the data structure. A system can include a processor; memory operatively coupled to the processor; and modules that include processor-executable instructions stored in the memory to instruct the system where the instructions include instructions to receive an unstructured grid of a multi-dimensional region; partition at least a portion of the unstructured grid into subdomains based at least in part on a cell number criterion; generate a hierarchical representation of the at least a portion of the unstructured grid that includes the subdomains and the cells; index cells in the subdomains based at least in part on the cell number criterion to define a data structure; and assign respective property values to respective indexed cells for at least a portion of the data structure. A computer-readable storage medium can include computer-executable instructions to instruct a computer where the instructions include instructions to: receive an unstructured grid of a multi-dimensional region; partition at least a portion of the unstructured grid into subdomains based at least in part on a cell number criterion; generate a hierarchical representation of the at least a portion of the unstructured grid that includes the subdomains and the cells; index cells in the subdomains based at least in part on the cell number criterion to define a data structure; and assign respective property values to respective indexed cells for at least a portion of the data structure. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment and various equipment associated with the geologic environment;

FIG. 2 illustrates an example of a sedimentary basin, an example of a method, an example of a formation, an example of a borehole, an example of a borehole tool, an example of a convention and an example of a system;

FIG. 3 illustrates an example of a method;

FIG. 4 illustrates an example of a structured grid and an example of an unstructured grid;

FIG. 5 illustrates example scenarios along with a structure spectrum as to grids;

FIG. 6 illustrates an example of a gridded geologic formation and an example of a matrix;

FIG. 7 illustrates an example of a method;

FIG. 8 illustrates examples of visualizations of data as associated with a structured grid and as associated with an unstructured grid;

FIG. 9 illustrates an example of a method;

FIG. 10 illustrates an example of a hierarchical representation of a region of an unstructured grid;

FIG. 11 illustrates examples of hierarchies and examples of data structures;

FIG. 12 illustrates examples of indexed data structures corresponding to the hierarchies of FIG. 11;

FIG. 13 illustrates an example of an unstructured grid, an example of a data structure, an example of a space-filling curve and an example of a map;

FIG. 14 illustrates examples of data structures;

FIG. 15 illustrates an example of a method;

FIG. 16 illustrates an example of a method;

FIG. 17 illustrates an example of a method;

FIG. 18 illustrates an example of a method;

FIG. 19 illustrates an example of a method;

FIG. 20 illustrates an example of a method; and

FIG. 21 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

As an example, a subsurface environment may be understood via data acquisition and analysis. As an example, seismology may be used to acquire data.

In such an example, the data may be subject to interpretation. For example, consider seismic interpretation as a process that involves examining seismic data (e.g., with respect to location and time or depth) to identify one or more types of subsurface structures (e.g., facies, horizons, faults, geobodies, etc.). Seismic data may optionally be interpreted with other data such as, for example, well log data. As an example, a process may include receiving data and generating a model based at least in part on such data.

A process may include determining one or more seismic attributes. A seismic attribute may be considered, for example, a way to describe, quantify, etc., characteristic content of seismic data. As an example, a quantified characteristic may be computed, measured, etc., from seismic data. As an example, a framework may include modules (e.g., processor-executable instructions stored in memory) to determine one or more seismic attributes. Seismic attributes may optionally be classified, for example, as volume attributes or surface attributes or one-dimensional attributes.

A seismic interpretation may be performed using displayable information, for example, by rendering information to a display device, a projection device, a printing device, etc. As an example, one or more color schemes (e.g., optionally including black and white or greyscale) may be referenced for displayable information to enhance visual examination of the displayable information. Where the human eye will be used or is used for viewing displayable information, a display scheme may be selected to enhance interpretation.

As an example, a geologic formation may be examined using seismology. For example, one or more seismic data acquisition techniques may be applied to acquire seismic data, which may be analyzed to understand better a geologic formation. As an example, seismic data and other data may be used to form a model of a geologic formation.

As an example, a geologic formation may be or include a reservoir. A reservoir may be defined as a subsurface body of rock that includes sufficient porosity and permeability to store and transmit fluids. As an example, seismic data and other data may be used to form a model of geologic formation that includes at least a portion of a reservoir. Such a model may be a grid cell model with one or more corresponding data structures suitable for input to a simulator. As an example, a simulator may simulate physical phenomena that may occur in a reservoir and output results (e.g., as values).

As an example, seismic interpretation may be performed using seismic to simulation software such as the PETREL® seismic to simulation software framework (Schlumberger Limited, Houston, Tex.), which includes various features to perform attribute analyses (e.g., with respect to a 3D seismic cube, a 2D seismic line, etc.). While the PETREL® seismic to simulation software framework is mentioned, other types of software, frameworks, etc., may be employed. As an example, a model built using a framework may be utilized by a simulator, for example, consider a reservoir simulator such as the ECLIPSE® simulator (Schlumberger Limited, Houston, Tex.), the INTERSECT® simulator (Schlumberger Limited, Houston, Tex.), etc.

As an example, “pay” may be a reservoir or portion of a reservoir that includes economically producible hydrocarbons (e.g., pay sand, pay zone, etc.). The overall interval in which pay sections occur may be referred to as the gross pay; where, for example, smaller portions of the gross pay that meet local criteria for pay (e.g., such as minimum porosity, permeability and hydrocarbon saturation) are net pay. As an example, a reservoir simulator may assess a geologic environment that includes a reservoir or reservoirs as to its physical properties that may be used to estimate pay.

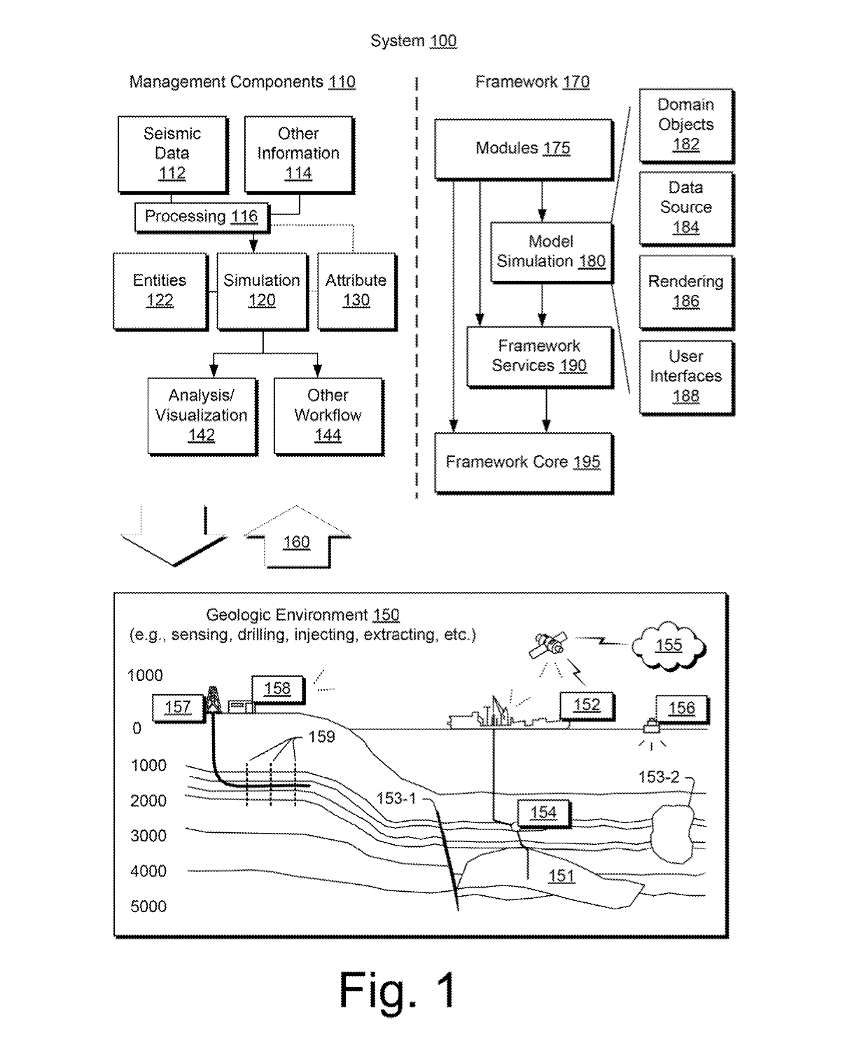

FIG. 1 shows an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE® reservoir simulator, the INTERSECT® reservoir simulator, etc. As an example, a simulation component, a simulator, etc. may optionally include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework. The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh. As an example, a mesh may be a grid. Such constructs (e.g., meshes or grids) may be defined by nodes, cells, intervals, segments, etc. As mentioned, a so-called meshless approach may be implemented, for example, based on points such as in a point cloud, etc.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

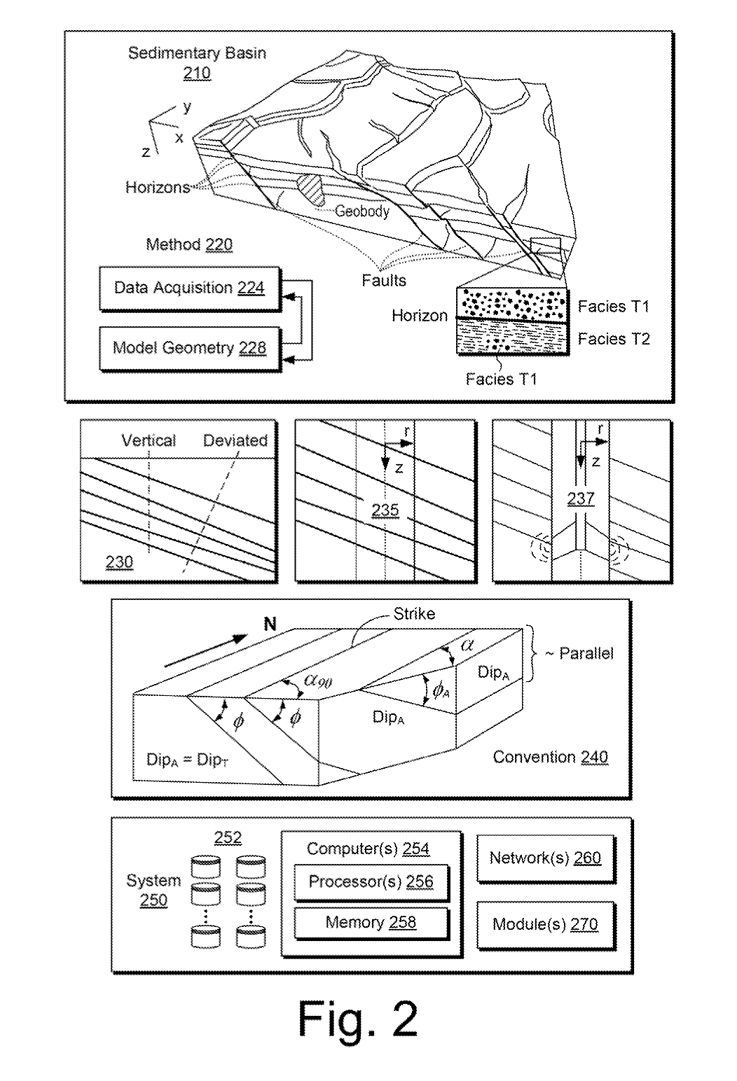

FIG. 2 shows an example of a sedimentary basin 210 (e.g., a geologic environment), an example of a method 220 for model building (e.g., for a simulator, etc.), an example of a formation 230, an example of a borehole 235 in a formation, an example of a convention 240 and an example of a system 250.

As an example, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A commercially available modeling framework marketed as the PETROMOD® framework (Schlumberger Limited, Houston, Tex.) includes features for input of various types of information (e.g., seismic, well, geological, etc.) to model evolution of a sedimentary basin. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230. As an example, a tool 237 may be positioned in a borehole, for example, to acquire information. As mentioned, a borehole tool may be configured to acquire electrical borehole images. As an example, the fullbore Formation Microlmager (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole may be vertical, deviate and/or horizontal. As an example, a tool may be positioned to acquire information in a horizontal portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG® framework (Schlumberger Limited, Houston, Tex.).

As to the convention 240 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 2, various angles φ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 240 of FIG. 2). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 240 of FIG. 2). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 2, the dip of a plane as seen in a cross-section perpendicular to the strike is true dip (see, e.g., the surface with 0 as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 240 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.). As an example, dip may change spatially as a layer approaches a geobody. For example, consider a salt body that may rise due to various forces (e.g., buoyancy, etc.). In such an example, dip may trend upward as a salt body moves upward.

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As an example, equations may be provided for petroleum expulsion and migration, which may be modeled and simulated, for example, with respect to a period of time. Petroleum migration from a source material (e.g., primary migration or expulsion) may include use of a saturation model where migration-saturation values control expulsion. Determinations as to secondary migration of petroleum (e.g., oil or gas), may include using hydrodynamic potential of fluid and accounting for driving forces that promote fluid flow. Such forces can include buoyancy gradient, pore pressure gradient, and capillary pressure gradient.

As shown in FIG. 2, the system 250 includes one or more information storage devices 252, one or more computers 254, one or more networks 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252.

As an example, the one or more modules 270 may include instructions (e.g., stored in memory) executable by one or more processors to instruct the system 250 to perform various actions. As an example, the system 250 may be configured such that the one or more modules 270 provide for establishing the framework 170 of FIG. 1 or a portion thereof. As an example, one or more methods, techniques, etc. may be performed using one or more modules, which may be, for example, one or more of the one or more modules 270 of FIG. 2.

As an example, a method can include structuring data associated with an unstructured grid in a “regular” type of data structure (e.g., a regular array, etc.). A resulting data structure may make presentation of properties of an unstructured grid (e.g., for the purposes of 2D or 3D visualization, etc.) more efficient (e.g., less demand as to computational resources, time, etc.).

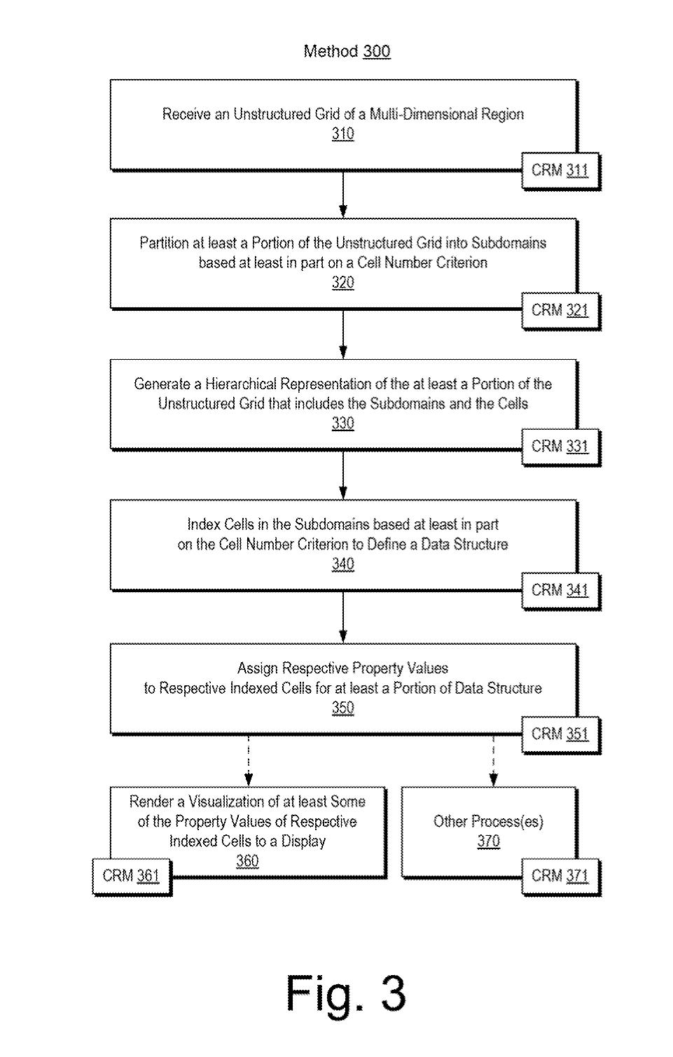

FIG. 3 shows an example of a method 300 that includes a reception block 310 for receiving an unstructured grid of a multi-dimensional region; a partition block 320 for partitioning at least a portion of the unstructured grid into subdomains based at least in part on a cell number criterion; a generation block 330 for generating a hierarchical representation of the at least a portion of the unstructured grid that includes the subdomains and the cells; an index block 340 for indexing cells in the subdomains based at least in part on the cell number criterion to define a data structure; an assignment block 350 for assigning respective property values to respective indexed cells for at least a portion of the data structure. As an example, the method 300 may include one or more other blocks such as, for example, a render block 360 and/or another process block 370. In the example of FIG. 3, the render block 360 can provide for rendering a visualization of at least some of the property values of the respective indexed cells to a display. As an example, the process block 370 may provide for extracting values for a particular area or areas of a model. As an example, in the method 300, the partition block 320 may partition a region into subdomains using a cell number criterion that is an integer, which may be a power of two integer (e.g., 4, 8, 16, etc.). As an example, a cell number criterion may be selectable, for example, with respect to intended use of a generated hierarchy. Where it is desirable to form larger blocks of data, a larger cell number may be selected as a cell number criterion. As an example, in the method 300, the index block 340 may include a space filling process, for example, that depends at least in part on a cell number criterion. For example, a cell number criterion (e.g., per the partition block 320) may be an integer (e.g., consider four, eight, etc.).

As an example, a method may include implementing a space-filling curve process, which may be a curve (e.g., optionally including linear segments) that can be in a multi-dimensional space (e.g., a two-dimension space, a three-dimensional space, etc.). As an example, a space-filling curve (e.g., or curves) may be constructed iteratively. As an example, a space-filling curve may be a sequence of piecewise linear continuous curves. As an example, a hierarchy may be represented by a space-filling curve at one scale and another space-filling curve at another scale. For example, a region with four subdomains may be represented by a Z-order curve that has a single “Z” shape and, where a cell number criterion is four, the subdomains may be represented by a Z-order curve with four connected “Z” shapes (e.g., that more closely approximate a space-filling limit that may be at an individual cell level).

As an example, a space-filling curve can be a continuous curve (e.g., in 2 or 3 (or higher) dimensions). A space-filling curve may be in Euclidean space (e.g., such as in a 2-dimensional plane (e.g., a planar curve) or as in 3-dimensional space (space curve)). As mentioned, a so-called Z-order curve is a type of space-filling curve. A method may implement a Z-order curve process and/or one or more other types of space-filling curve processes. As an example, a curve may be intersecting (e.g., at one or more points) or may not be intersecting. As an example, a curve may be a fractal curve (e.g., a self-similar fractal curve). As an example, a space-filling curve may be a Peano curve, a Gosper curve, a Moore curve, a Hilbert curve, etc.

In the method 300, the generated hierarchical representation can be indexed to form a data structure, which may be an array. Such a data structure may be used to store information associated with the unstructured grid in a manner that is more efficient than a data structure associated with the unstructured grid with, for example, cell IDs in its native state.

As an example, a hierarchical representation may be a tree with nodes and branches where nodes may be generated via recursive partitioning of an unstructured grid. The hierarchical representation may be indexed such that, for example, cells correspond to entries in an array. For example, for a two-dimensional array, individual cell indices for cells 0 to 15 may correspond to array indices I and J of a 4×4 array. In such an example, for four subdomains and four cells per subdomain, the structure of the array (e.g., a data structure) may follow a Z-order (e.g., as in a Z-order curve) or, for example, an approximate Z-order.

As an example, a data structure per the method 300 of FIG. 3 may allow for storing data with respect to an unstructured grid. As an example, a method may include selecting a region of an unstructured grid and accessing a block of data organized according to a data structure per the method 300 of FIG. 3. For example, an unstructured grid may be associated with a data structure such that regions of the unstructured grid (e.g., cell regions, etc.) correspond to blocks of the data structure. As an example, a method may include rendering a visualization of a geologic formation associated with an unstructured grid, selecting a region and, based at least in part on the selecting, accessing a block of data from a data structure, which may be an array. In such an example, the selecting may select a point with an associated dimension (e.g., radius, etc.). The method may match that point and its dimension with a corresponding block size of a data structure that corresponds to a subdomain of an unstructured grid (as represented by a hierarchy). For example, a point may be associated with a subdomain that includes 16 cells as represented by a 4×4 block of an array where the 16 cells cover a region of the unstructured grid. As an example, where “fill” is used (e.g., a number of cells in a subdomain is less than a maximum cell number), a method may still access a block (e.g., a 4×4, etc.), however, data may be “fill” data for one or more of those entries. As an example, processing of data of a data structure may account for “fill”, for example, to not interfere with or alter calculations for data of the non-fill entries of the data structure.

As an example, data associated with an unstructured grid may be represented in an array where the array may be used to extract select data in blocks, which may correspond to individual regions, subdomains and cells (e.g., levels of detail) of the unstructured grid. In such an example, the array may be a data structure defined per a method such as the method 300 of FIG. 3. As an example, extracted data may be processed, for example, for visualization, for analysis, etc.

The method 300 is shown in FIG. 3 in association with various computer-readable media (CRM) blocks 311, 321, 331, 341, 351, 361 and 371. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 300. As an example, a computer-readable medium (CRM) may be a computer-readable storage medium that is non-transitory and that is not a carrier wave. As an example, one or more of the block 311, 321, 331, 341, 351, 361 and 371 may be in the form of a module such as, for example, one of the modules 270 of the system 250 of FIG. 2. As an example, the method 300 of FIG. 3 may be implemented as part of the analysis and visualization module 142 of FIG. 1. As an example, the method 300 of FIG. 3 may be implemented as a plug-in, add-on, etc., for example, as to a framework such as the framework 170 of FIG. 1.

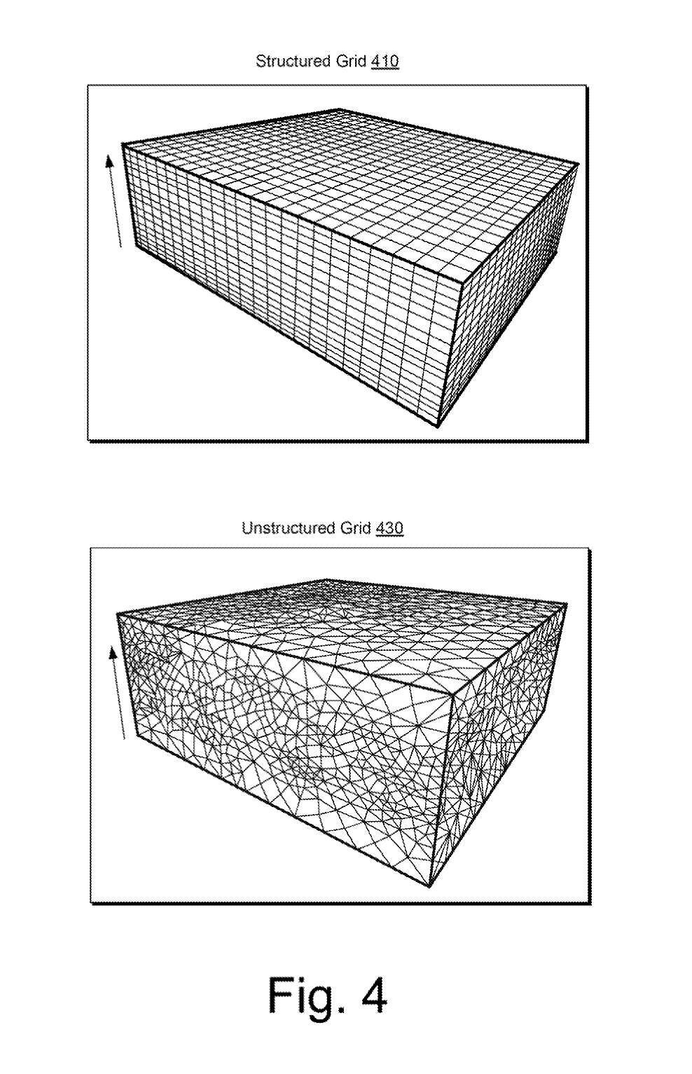

FIG. 4 shows an example of a structured multi-dimensional grid 410 and an unstructured multi-dimensional grid 430. The grid 410 may be defined by Cartesian coordinates and/or indices where cells of the grid 410 may be cuboid or regular hexahedra. As an example, information associated with the cells of the grid 410 may be represented by a three-dimensional array, for example, where a property value of an individual cell is accessible via a specified x, y and z (e.g., or I, J, and K) triple, which may be ordered in a spatially corresponding manner (e.g., by rows, columns, etc.). In other words, the grid 410 may be directly represented mathematically by a three-dimensional array where ordering of entries in the three-dimensional array corresponds directly to ordering of cells in the grid 410.

As to the grid 430, the cells differ in shape and size, which may, for example, allow the cells to more closely approximate features that may exist in a geologic formation. For example, cells may spatially conform to a fracture, a fault, etc. In such an example, one may more readily visualize a feature or features merely by examining an unstructured grid, as a structured grid may be no more than a regular stack of cuboids. Further, where property values are rendered to a display, for example, on a cell-by-cell basis of an unstructured grid, physical phenomena may be more readily understood with respect to spatial locations of a feature or features.

As to representing the grid 430 in a mathematical form, it may not be readily amenable to a simple x, y and z (e.g., or I, J and K) approach where ordering can be preserved. For example, the grid 430 may be not be directly representable mathematically by a three-dimensional array where ordering of entries in the three-dimensional array corresponds directly to ordering of cells in the grid 430. For such a reason, structured grids such as the grid 410 may provide some “mathematical” benefits over an unstructured grid such as the grid 430.

As mentioned, a method such as, for example, the method 300 of FIG. 3, may generate a hierarchical representation of an unstructured grid that can be indexed to define a data structure such as, for example, an array. In such an example, the data structure may be regular; whereas, a data structure that corresponds to cell IDs of the unstructured grid in its native state may be irregular (e.g., not as efficient for purposes of storage and retrieval of information). As mentioned, a data structure defined by a method such as the method 300 of FIG. 3 may allow for storage and/or retrieval of information as blocks (e.g., two-dimensional blocks, three-dimensional blocks, etc.). As an example, a block of a data structure may correspond to a physical region of a geologic environment as represented by an unstructured grid.

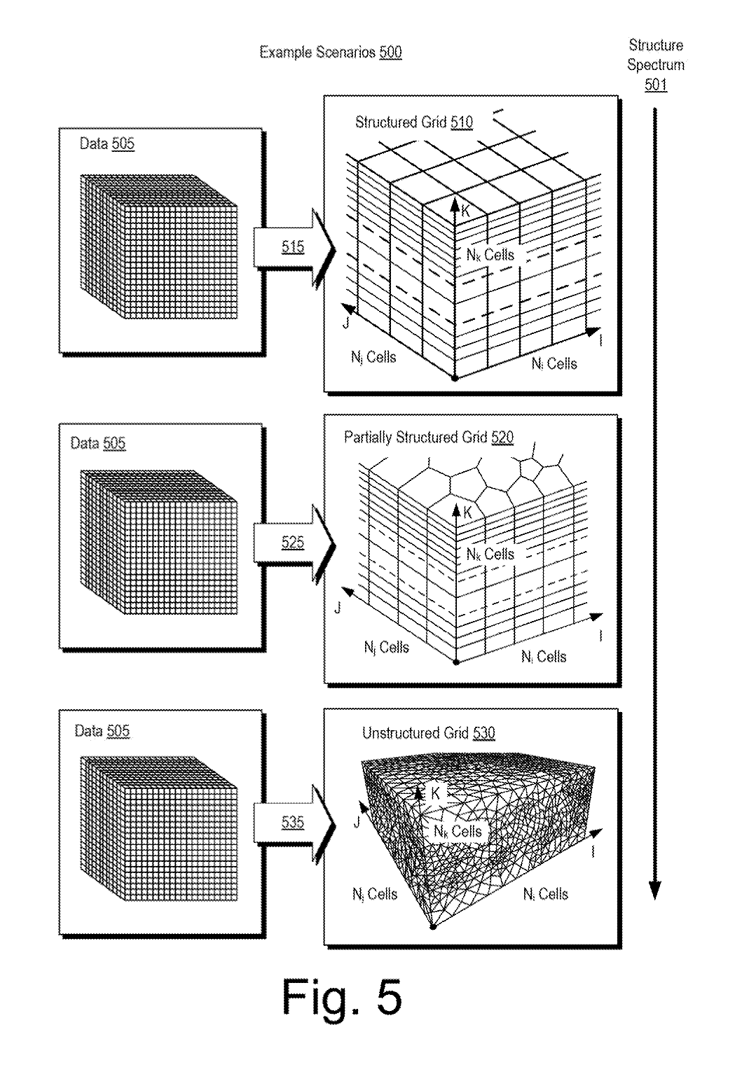

FIG. 5 shows example scenarios 500 along a structure spectrum 501. In the example scenarios 500, volumetric data 505 are shown as being ordered according to a three-dimensional mathematical array. For example, the data 505 may be seismic data (e.g., a seismic volume or cube), attribute data (e.g., an attribute volume of cube), or other property data. As an example, the volumetric data 505 may correspond to a three-dimensional region (e.g., a geologic formation, etc.). As explained, seismic data may be acquired in inline and crossline directions and structured in a data structure where time may be equated to depth. In such an example, the seismic data may be in a three-dimensional array where each entry in the array corresponds to a physical volume of the three-dimensional region and where each entry may be referred to as a volume element or voxel, which may be defined, for example, by physical length, width and depth.

In the example scenarios 500, processes 515, 525 and 535 are shown that transform the data 505 to corresponding grids 510, 520 and 530, which may be defined at least in part via structure along the structure spectrum 501. In the example scenarios 500, each of the grids 510, 520 and 530 is shown along with corresponding three-dimensional indices I, J and K. As an example, the data 505 may be organized via three-dimensional mathematical indices such as, for example, x, y and z (e.g., of a three-dimensional array).

As to the process 515, entries of the data 505 may be readily mapped to cells of the grid 510. For example, mapping of x, y and z entries of the data 505 to cells of the grid 510 may be consider voxel size and cell size where voxels and cells are cuboids. As to the process 525, it may be more complex than the process 515 as the grid 520 is not as structured as the grid 510. In such an example, the process 525 can account for irregularities of the grid 520 in the I and J directions to assure that data are properly mapped. As to the process 535, it may be more complex than the process 525 as the grid 530 is not as structured as the grid 520. In such an example, the process 535 can account for irregularities of the grid 530 in the I, J and K directions to assure that data are properly mapped.

The example scenarios 500 of FIG. 5 illustrate how data mapping may become more complex with decreasing regularity of grid structure. Grid structure characteristics can also be factors as to other processes. For example, one or more grid structure characteristics may impact a simulation process where information is to be represented mathematically for purposes of computation, etc.

As an example, a method such as, for example, the method 300 of FIG. 3, may allow for storage of information associated with an unstructured grid in a more organized manner such as, for example, organized via three-dimensional mathematical indices such as, for example, x, y and z (e.g., of a three-dimensional array). In such a method, retrieval of information may occur, for example, on a block by block basis; whereas, a data structure associated with an unstructured grid in its native state, while including blocks, may not have correspondence between cells of the unstructured grid and the blocks. For example, a block of a data structure associated with an unstructured grid in its native state may store data for cells that are not physically proximate to one another. Thus, to access data for a region, a look-up may act to pull data from multiple disjointed regions of an array, which may be quite inefficient. In comparison, a data structure defined per a method such as, for example, the method 300 of FIG. 3, may make retrieval of data more efficient.

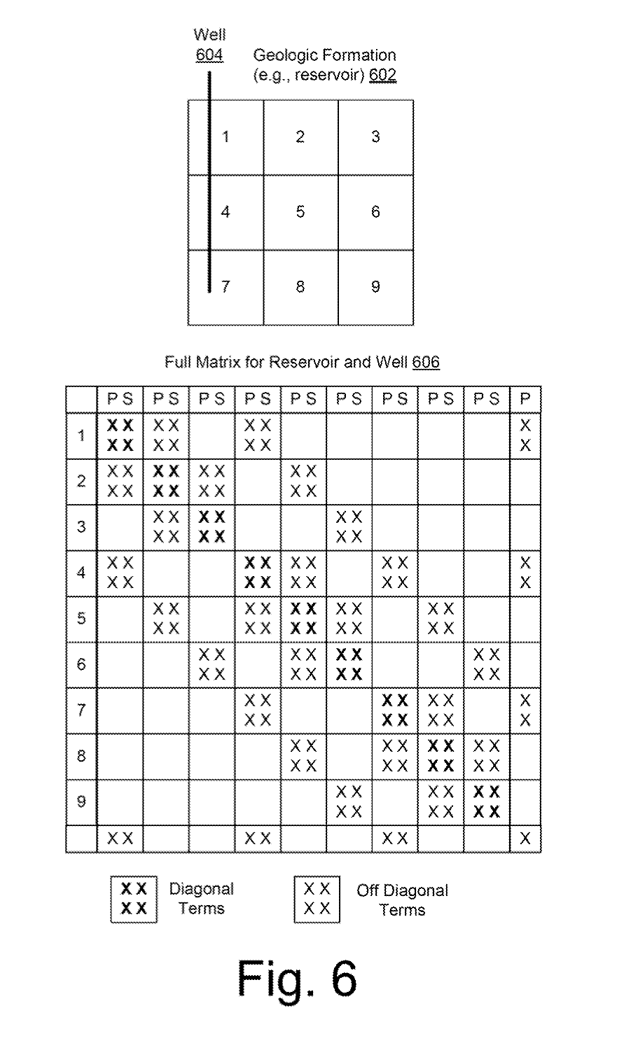

FIG. 6 shows an example of a geologic formation 602 and a well 604 and an example of a corresponding matrix 606 (e.g., a Jacobian matrix of derivatives, etc.). As shown, the geologic formation 602 is spatially discretized into nine cells that are regularly ordered in space as three layers with three cells in each layer. In the simplistic representation of the geologic formation 602 of FIG. 6, the cells are numbered 1 to 9 and their corresponding equations for pressure (P) and saturation (S) can be represented readily in the matrix 606 as diagonal terms and various off diagonal terms that may define a band-width (e.g., a banded matrix). For example, cell 1 has neighboring cells 2 and 4 that result in off diagonal terms (see, e.g., the entries in column 1, rows 2 and 4). In the example of FIG. 6, the presence of the well 604 introduces additional terms to the system of equations for the geologic formation 602. As shown, these additional terms appear along a border of the matrix 606 as associated with cells 1, 4 and 7. Thus, the matrix 606 includes diagonal terms and various off diagonal terms that may collectively define a band-width as well as border terms that may define a border width.

As explained with respect to FIG. 6, characteristics of a spatial grid (e.g., structured, unstructured, etc.) can dictate how equations are setup in a simulator (e.g., matrix size, condition, sparseness, etc.), which may impact computational resource demands, computation time, convergence, etc. As an example, a structured grid may provide a matrix (e.g., a Jacobian matrix) that may be less sparse, more “organized”, etc., when compared to a matrix associated with an unstructured grid. Based on such factors, a reservoir simulator may be configured to perform simulations of geologic formations represented by structured grids.

As an example, a method such as, for example, the method 300 of FIG. 3, may be applied to results from a simulator, for example, to represent “structured” results using an unstructured grid. For example, a data structure may be created for an unstructured grid where the data structure may be an array. In such an example, the array may include entries that stem from a hierarchical representation of the unstructured grid, for example, as generated via recursive partitioning of the unstructured grid. As an example, a simulator may receive information specified according to a structured spatial grid that represents a geologic formation that includes a reservoir. In such an example, the simulator may output results that correspond to points, volumes, etc. of the structured spatial grid. As an example, a method may include representing at least a portion of the results using an unstructured grid, for example, where a “regular” data structure (e.g., multi-dimensional array) is associated with the unstructured grid. In such an example, visualization of such results via an unstructured grid may enhance understanding of physical phenomena associated with the geologic formation.

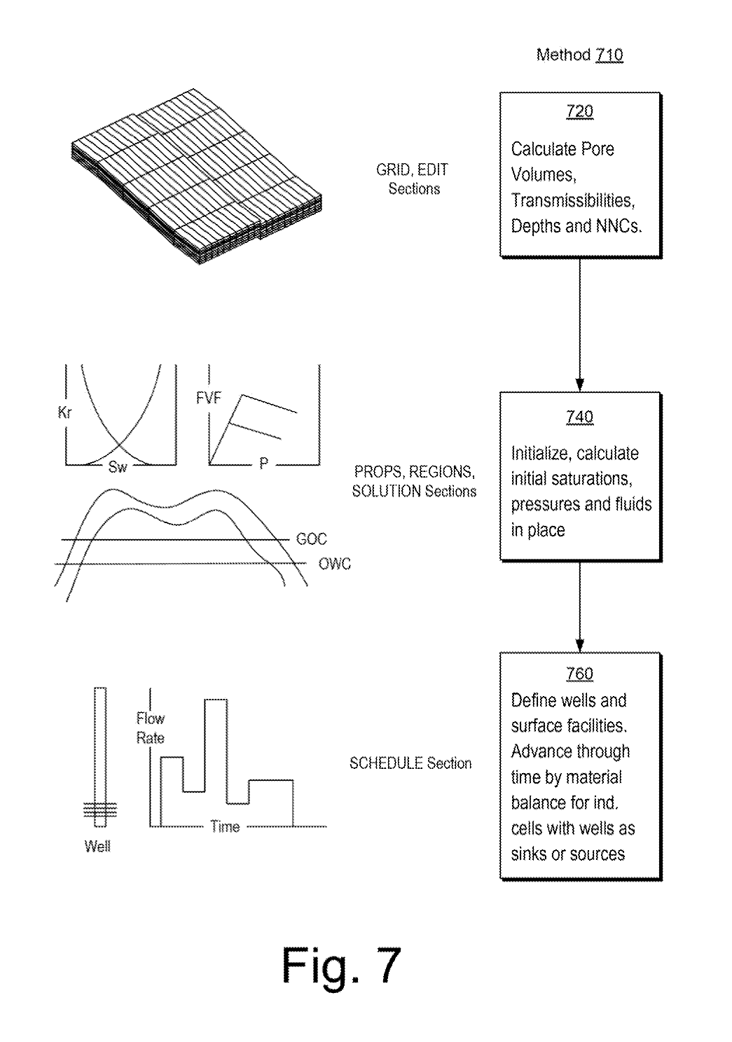

FIG. 7 shows an example of a method 710 that includes a calculation block 720 for calculating pore volumes, transmissibilities, depths and NNCs, an initialization and calculation block 740 for initializing and calculating initial saturations, pressure and fluids in place, and a definition and time progression block 760 for defining one or more wells and surface facilities and advancing through time, for example, via material balances for individual cells of a grid cell model of a geologic formation (e.g., with the one or more wells as individual sinks and/or sources).

As an example, a grid cell model can include grid cells where properties are defined with respect to a position or positions of a grid cell. For example, a property may be defined as being at a centroid of a grid cell. As an example, consider cell properties such as porosity (e.g., a PORO parameter), permeability in an x-direction (e.g., a PERMX parameter), permeability in a y-direction (e.g., a PERMY parameter), permeability in a z-direction (e.g., a PERMZ parameter) and net-to-gross ratio (e.g., NTG) being defined as averages for a cell at a center of a cell. In such an example, the directions x, y and z may correspond to directions of indices (e.g., I, J and K) of a grid that may model a geologic formation.

As to the initialization and calculation block 740, for an initial time (e.g., t₀), saturation distribution within a grid model of a geologic formation and pressure distribution within the grid model of the geologic formation may be set to represent an equilibrium state (e.g., a static state or “no-flow” state), for example, with respect to gravity. As an example, to approximate the equilibrium state, calculations can be performed. As an example, such calculations may be performed by one or more modules. As an example, a reservoir simulator may include a module for initialization using data to compute capillary and fluid gradients, and hence fluid saturation densities in individual cells of a grid model that represents a geologic formation.

Initialization aims to define fluid saturations in individual cells such that a “system” being modeled is in an equilibrium state (e.g., where no external forces are applied, no fluid flow should take place in a reservoir, a condition that may not be obeyed in practice). As an example, consider oil-water contact and assume no transition zone, for example, where water saturation is unity below an oil-water contact and at connate water saturation above the contact. A cell (e.g., or grid cell) may represent a point or points in space for purposes of simulating a geologic formation. Where an individual cell represents a volume and where that individual cell includes, for example, a center point for definition of properties, within the volume of that individual cell, the properties may be constant (e.g., without variation within the volume). In such an example, that individual cell includes one value per property, for example, one value for water saturation. As an example, an initialization process can include selecting a value for individual properties of individual cells.

As an example, saturation distribution may be generated based on one or more types of information. For example, saturation distribution may be generated from seismic information and saturation versus depth measurements in one or more boreholes (e.g., test wells, wells, etc.).

As mentioned, a reservoir simulator may advance in time. As an example, a numeric solver may be implemented that can generate a solution for individual time increments (e.g., points in time). As an example, a solver may implement an implicit solution scheme and/or an explicit solution scheme, noting that an implicit solution scheme may allow for larger time increments than an explicit scheme. Times at which a solution is desired may be set forth in a “schedule”. For example, a schedule may include smaller time increments for an earlier period of time followed by larger time increments.

A solver may implement one or more techniques to help assure stability, convergence, accuracy, etc. For example, when advancing a solution in time, a solver may implement sub-increments of time, however, an increase in the number of increments can increase computation time. As an example, an adjustable increment size may be used, for example, based on information of one or more previous increments.

As an example, a numeric solver may implement one or more of a finite difference approach, a finite element approach, a finite volume approach, etc. As an example, the ECLIPSE® reservoir simulator can implement central differences for spatial approximation and forward differences in time. As an example, a matrix that represents grid cells and associated equations may be sparse, diagonally banded and blocked as well as include off-diagonal entries.

As an example, a solver may implement an implicit pressure, explicit saturation (IMPES) scheme. Such a scheme may be considered to be an intermediate form of explicit and implicit techniques. In an IMPES scheme, saturations are updated explicitly while pressure is solved implicitly.

As governing equations tend to be non-linear (e.g., compositional, black oil, etc.), a Newton-Raphson type of technique may be implemented, which includes determining derivatives, iterations, etc. For example, a solution may be found by iterating according to the Newton-Raphson scheme where such iterations may be referred to as non-linear iterations, Newton iterations or outer iterations. Where one or more error criteria are fulfilled, the solution procedure has converged, and a converged solution has been found. Thus, within a Newton iteration, a linear problem is solved by performing a number of linear iterations, which may be referred to as inner iterations.

As an example, a solution scheme may be represented by the following pseudo-algorithm:

// Pseudo-algorithm for Newton-Raphson for systems
initialize(v);
do {

//Non-linear iterations
formulate_non_linear_system(v);
make_total_differential(v);
do {

// Linear iterations:
update_linear_system_variables(v);

}
while((linear_system_has_not_converged(v));
update_non_linear_system_after_linear_convergence(v);

}
while((non_linear_system_has_not_converged(v))

As an example, a solver may perform a number of inner iterations (e.g., linear) and a number of outer iterations (e.g., non-linear). As an example, a number of inner iterations may be of the order of about 10 to about 20 within an outer iteration while a number of outer iterations may be about ten or less for an individual time increment.

As mentioned, a method such as, for example, the method 300 of FIG. 3, may be applied to results of a simulator. For example, consider receiving results of the method 710 of FIG. 7 (e.g., for one or more times) and representing such results according to a data structure associated with an unstructured grid. In such an example, results may be represented at one or more levels of detail (LoD) as associated with a hierarchical representation of the unstructured grid. For example, a hierarchical representation may be generated via recursive partitioning of an unstructured grid and then used to form a regular data structure. Such a data structure may organize data for cells of the unstructured grid where such data may be proximate for proximate cells.

As an example, a method such as, for example, the method 300 of FIG. 3, may be applied to input values to a simulator, intermediate values of a simulator, etc. For example, consider receiving information associated with the block 720 and/or the block 740 of the method 710 of FIG. 7 (e.g., for one or more times) and representing such information according to an unstructured grid. In such an example, information may be represented at one or more levels of detail (LoD) as associated with a hierarchical representation of the unstructured grid.

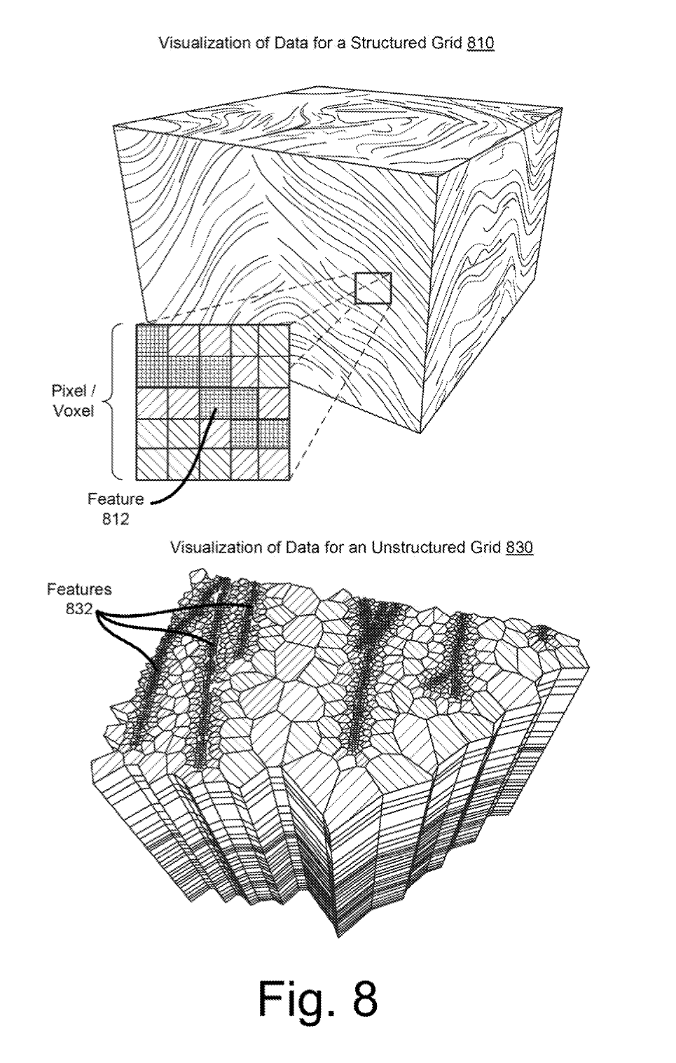

FIG. 8 shows an example of a visualization of data for a structured grid 810 and an example of a visualization of data for an unstructured grid 830 that is at least in part unstructured in two dimensions. For example, the unstructured grid 830 may be defined with respect to indices I, J and K; whereas, the unstructured grid 830 is unstructured with respect to the I and J indices (see, e.g., the grid 520 of FIG. 5). In the examples of FIG. 8, the grid cells are illustrated via black and white hatching, which may represent, for example, grayscale values, color values, etc.

As illustrated in FIG. 8, the structured grid 810 is composed of pixels or voxels that are discrete elements that can be assigned a particular value. In such an example, the shape and size of the discrete elements may bear little to no relationship to shape and size of a feature. For example, consider a feature 812 that may be a structure in a geologic environment (e.g., a geologic formation). As shown, with respect to a two-dimensional plane defined by the grid 810, the feature 812 is represented via a series of pixels where each pixel has a corresponding value.

As to the grid 830, features 832 are illustrated as being represented by cells that conform to shapes of the features. In such an example, each of the features 832 may be represented by smaller cells where cell size may increase as distance from a respective one of the features increases. As to physical phenomena, properties, etc. that may be associated with a geologic environment (e.g., a geologic formation) represented by the grid 830, a gradient may exist as to values where size of cells may depend on the gradient. For example, where a gradient is “steep”, cells may be sized to have a cell density that can illustrate the steepness of the gradient. And, for example, where a region includes values that are relatively constant, an individual cell may be sized to “cover” the region with, for example, an average value.

As an example, a region may be represented at least in part by an unstructured grid where a number of cells of the unstructured grid may be less than, for example, a number of cells associated with data, which may be, for example, property or other data. As an example, data may be seismic data, attribute data, simulation data, etc. As an example, a region represented by an unstructured grid may be more “compact” than a region represented by a structured grid. For example, a data structure for such an unstructured grid may be stored in less memory space than a data structure for an “underlying” structured grid (e.g., a grid from which data are taken for representation via the unstructured grid).

As mentioned, an unstructured grid in its native state may include cell IDs that are associated with an irregular data structure (e.g., data entries for two neighboring cells may not be neighboring entries in the irregular data structure). In such an example, handling of data from one or more sources to make such data appropriate for presentation with respect to cells of the unstructured grid may be more demanding than if the cell IDs of the unstructured grid were associated with a more regular data structure. As mentioned, a method such as, for example, the method 300 of FIG. 3, may generate a data structure for an unstructured grid that is more regular than a data structure corresponding to the unstructured grid in its native state. In such an example, data handling may be less demanding for the generated data structure when compared to a less regular data structure.

FIG. 8 demonstrates how spatially-varying properties (e.g., pressure, temperature, permeability, saturation, density, etc.) may be represented visually by dividing a volume of interest into non-overlapping sub-volumes (e.g., cells), which, when taken together, form a grid. As an example, an association of an individual cell with a piece of data (e.g., numerical or other type of data) may be used to represent spatially-varying properties.

As an example, a reservoir simulator may process a model of a geologic environment where the model may include a grid cell model with a number of cells of the order of hundreds of thousands or more (e.g., even up to a billion or more cells). As an example, such a simulator may run in series and/or in parallel. As an example, a simulator may be executed using high performance computing clusters. As computing technology and techniques advance, models may become even larger, for example, as fidelity of available data continues to improve.

As an example, a simulator may include one or more modules that can provide for visualization of information. As an example, visualization capabilities may be included in a framework (e.g., PETREL® framework, the OCEAN® framework, etc.). As an example, a simulator may operate in a batch mode where simulation results may be stored to one or more data storage devices. In such an example, the simulator may be “free” to then process another batch, for example, rather than being tied up for purposes of visualization of information.

As an example, a computing system such as, for example, a workstation, may be used for purposes of visualization of information while, for example, a mainframe, supercomputer, computing cluster, etc. is available as a simulator purposes of simulation. In such an example, the computing system may access data stored to one or more data storage devices by the simulator and then process at least a portion of the data to generate one or more visualizations.

As an example, a computing system may be used for purposes of visualization of information by accessing data stored to one or more storage devices where such data may be, for example, seismic data (e.g., or attribute data, which may be derived at least in part from seismic data). As an example, data such as seismic data may be formatted according to one of the SEG-Y format standards (Society of Exploration Geophysicists), the ZGY format standard (e.g., a bricked format) or another format. As an example, seismic data may be stored with trace header information, which may assist in analysis of the seismic data. Seismic data may optionally be accessed, for example, according to a number of traces (e.g., in an inline, crossline or inline and crossline directions), which may be entire traces or portions thereof (e.g., for one or more particular times or depths). As an example, given a number of traces across a region, a process may access some of those traces in a sub-region by specifying inline and crossline indices (e.g., or geographic or grid coordinates) as well as a time or depth window.

As an example, a method can include accessing data from one or more data storage devices and representing at least a portion of the data as a visualization using an unstructured grid. In such an example, the data may be data associated with a simulator (e.g., as stored by a simulator, etc.), data associated with a seismic acquisition technique (e.g., as stored by acquisition equipment), or other type of data.

As an example, a method can optimize data transfer, display and memory management of properties associated with one or more regular grids for association with one or more at least partially unstructured grids (e.g., of arbitrary structure and regularity, or lack thereof, etc. As an example, a grid may be “unstructured” in multiple dimensions and be considered a partially unstructured grid or, for example, a wholly unstructured grid.

As an example, a method can include utilizing structured data types such as regular 3D arrays to efficiently represent properties of an unstructured grid for the purposes of 2D or 3D visualization. In such an example, the method may implement one or more techniques that can expedite processing, reduce computation demands, etc.

As an example, a method can include handling large quantities of structured data to be applied to one or more unstructured grids. As an example, a method can include loading values to be displayed, rapidly providing approximate representations of the data and, for example, managing memory requirements associated with one or more large data volumes.

As an example, a method may include determining an integer numbering scheme for unstructured grid cells that includes assigning nearby numbers to geometrically proximal cells. For example, given a set of grid cells, the set may be partitioned into a number of subsets (e.g., an integer value of about four or more) of connected cells so as to have as a similar a number of cells in each subset (e.g., as similar a number of cells in each subset as may be desired, according to one or more cell number criteria). In such an example, the subsets may be recursively partitioned, for example, until a stopping criterion on a number of cells suitable for partitioning is reached. In such an example, a hierarchy may be derived from the partitioning and, for example, used to assign integer numbers to each cell so as to follow an ordering, which may be, for example, an approximate z-curve ordering.

As an example, consider a region that is partitioned into eight subdomains (e.g., a subdomain number criterion) where each of the subdomains may include at most four cells (e.g., a cell number criterion). In such an example, a hierarchy can include levels of detail (LoD) where one level of detail may correspond to one or more of the eight subdomains and where another level of detail may correspond to one or more of a maximum of 32 cells. In such an example, the region may be a three-dimensional region. As an example, a region may be a two-dimensional region. In such an example, consider partitioning the region into four subdomains (e.g., a subdomain number criterion) where each of the subdomains includes at most four cells (e.g., a cell number criterion). As an example, a region may optionally be a subdomain of a larger region. In such a manner a hierarchy may be generated that include a plurality of levels of detail (LoDs).

As an example, a method can include receiving an unstructured grid (e.g., consider cells numbered 0 to 13, 14 cells total) and recursively partitioning the unstructured grid into subdomains using a cell number criterion (e.g., consider a maximum of four cells per subdomain). In such an example, where cells of the unstructured grid include a native numbering, the cells may be re-numbered such that for a subdomain, the cells contained within it may be contiguous (e.g., including one or more fill values, if present). As an example, if a subdomain contains further partitioning into subdomains, the union of these cell indices may be contiguous. For example, consider selecting one subdomain and labeling the cells within it arbitrarily from 0 to 3, then the other sibling subdomains which share the same parent subdomain can be numbered contiguously from 4 to 15 (e.g., where a total of four subdomains exist with a maximum number of cells per subdomain of four). As an example, where more cells exist in a model, a numbering scheme can continue such that a hierarchical structure (e.g., a tree structure) may be obtained where the indices of children are bounded by the indices range of a parent. Such an approach to numbering may be spatially compact where partitioning organizes cells into sets which are spatially close.

As an example, indexing to define a data structure may include implementing a space-filling curve process (e.g., Z-ordering, etc.). For example, to layout data of a regular tree structure into a structured array, Z-ordering may be applied. For example, a Z-order approach may implement a Z-order curve in 2 and/or 3 dimensions, for example, where using a maximum of 4 or 8 cells per subdomain, respectively. As an example, a method can include mapping cell indices onto a 4×4 grid following a Z-order curve (e.g., or other type of space-filling curve).

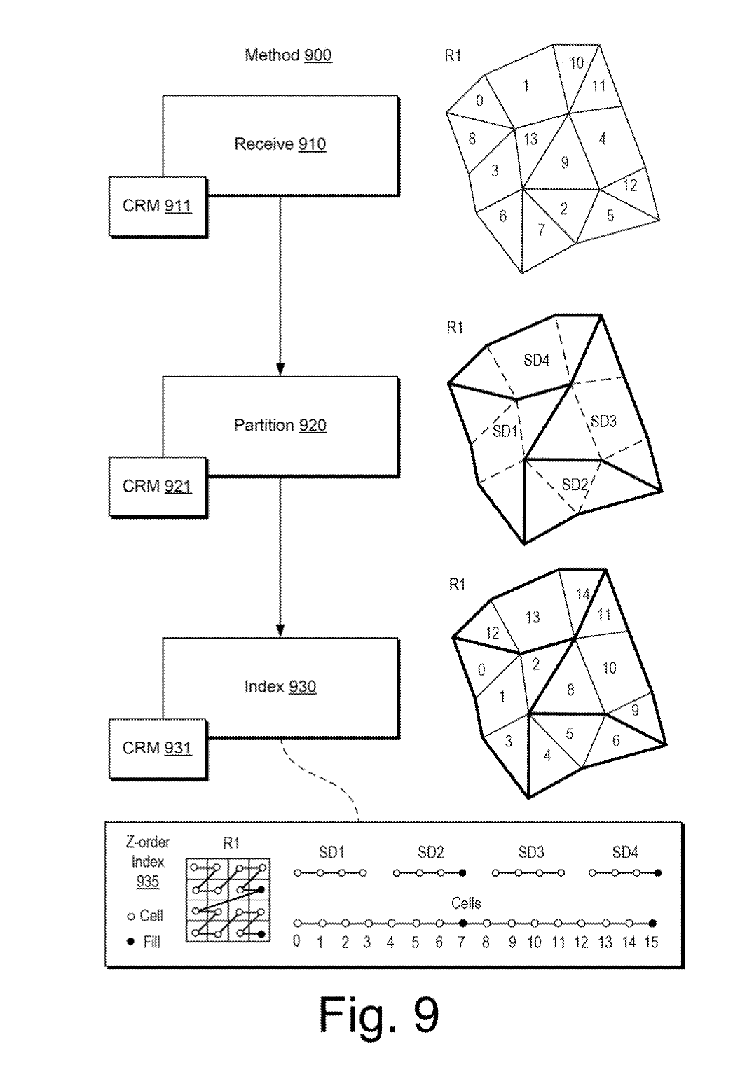

FIG. 9 shows an example of a method 900 that includes a reception block 910 for receiving a region, a partition block 920 for partitioning the region into subdomains that include cells and an index block 930 for indexing cells in the subdomains for purposes of defining a data structure.

In the example of FIG. 9, the region (R1) includes cells numbered from 0 to 14 (i.e., 15 cells) defined by an unstructured grid. As shown, the region (R1) is partitioned into four subdomains (SD1 to SD4) where, at most, an individual subdomain includes four cells. As an example, after partitioning, a hierarchical representation of the region R1 may be generated that includes the subdomains and cells. As an example, indexing may assign indices to cells in each subdomain, for example, in a manner that can account for one or more “unused” indices, which can result from a subdomain having fewer cells than a cell number criterion. As an example, indexing can index the cells of the four subdomains via a cell number criterion that provides for four cell indices per subdomain. In such an example, as the subdomains SD2 and SD4 include three cells rather than four cells each, an index is left over in each of the subdomains SD2 and SD4 (e.g., the index 7 of the subdomain SD2 and the index 15 of the subdomain SD4).

As illustrated in FIG. 9, the index block 930 may include indexing via a space-filling curve process such as, for example, per a Z-order index block 935. For example, in mathematics, a so-called Z-order (e.g., or Morton order, etc.) may be a function that can map multi-dimensional data to reduce its dimension. For example, Z-ordering may map multi-dimensional data to a single dimension while preserving locality of data points. As illustrated, the region R1 may be represented by four connected “Zs”, one for each subdomain SD1, SD2, SD3 and SD4 of the region R1. Such an approach may provide for indexed cells in a hierarchical representation that includes, for example, subdomains “above” cells. As illustrated, a vector may be formed with indices from 0 to 15 that represent the cells 0, 1, 2, 3, 4, 5, 6, 8, 9, 10, 11, 12, 13 and 14, which in the region R1, correspond to the cells 8, 3, 6, 7, 2, 5, 9, 12, 4, 11, 0, 1 and 10, respectively. In the indexed representation, the neighboring cells are now closer to each other than in the ordering associated with the unstructured region, as received.

As an example, a Z-order process (e.g., or other space-filling curve process) may be approximate, for example, when combined with a recursive partitioning process that includes a cell number criterion. In such an example, a subdomain created via partitioning may include fewer cells than a cell number criterion such that a “fill” Z-order point exists in a hierarchy that does not “physically” exist in a corresponding subdomain.

As an example, indexing may be applied to cell indices to, for example, define a data structure (e.g., an array). For example, cell indices may be organized by subdomains in a Z-pattern as blocks of an array where within individual blocks cell indices may be organized in Z-patterns.

As an example, a method can include re-numbering of cells, which may be considered indexing or re-indexing. Such a method may be an inherent result of partitioning that can generate a hierarchical representation of an unstructured grid. Such cell numbers or indices may be indexed to define a data structure. For example, cell with an index of “4” may be indexed in an array with indices I, J as an entry I=2, J=2. Such a cell can be in a block of the array that includes cells and/or fill of a subdomain.

As illustrated in FIG. 9, the unstructured grid of the region R1 includes an initial ordering of integer cell indices (e.g., cell numbers). Partitioning of the partition block 920 can define the unstructured grid via four subdomains, for example, according to a cell number criterion where each of the four subdomains may be set to include four or fewer cells. Next, a new ordering or indexing of the cells is achieved via indexing of the index block 930.

As an example, per the Z-order block 935, a new ordering may be a Z-order that can be determined by assigning contiguous integer indices to cells within a subdomain, which can help to ensure that geometric proximity is strongly associated with cell index proximity (e.g., for purposes of defining a data structure). For example, in the ordering of R1 as received, the cell with index 1 is not adjacent to the cell with index 2, rather, cells indexed 13 and 9 are disposed between the cells indexed 1 and 2. In contrast, through partitioning into subdomains, the cell indexed 1 is now indexed 13 and adjacent to cells indexed 12 and 14 of the subdomain SD4 while the cell indexed 2 is now indexed 5 and adjacent to cells indexed 4 and 6 of the subdomain SD2.

As an example, a method can include allocating to each of a plurality of subdomains an index-range wide enough to accommodate the subdomain with the most cells; whereas, for those subdomains with fewer cells, not every index in that subdomain will be used; these unused indices may be referred to as “fill” indices or nodes (e.g., of a hierarchical representation, etc.). The values of the “fill” nodes may not be directly provided as they do not have corresponding physical cells, however one or more of them may, for example, contribute to forming one or more averaged versions of properties at lower levels of detail (e.g., or one or more other computed values such as, for example, one or more statistical values).

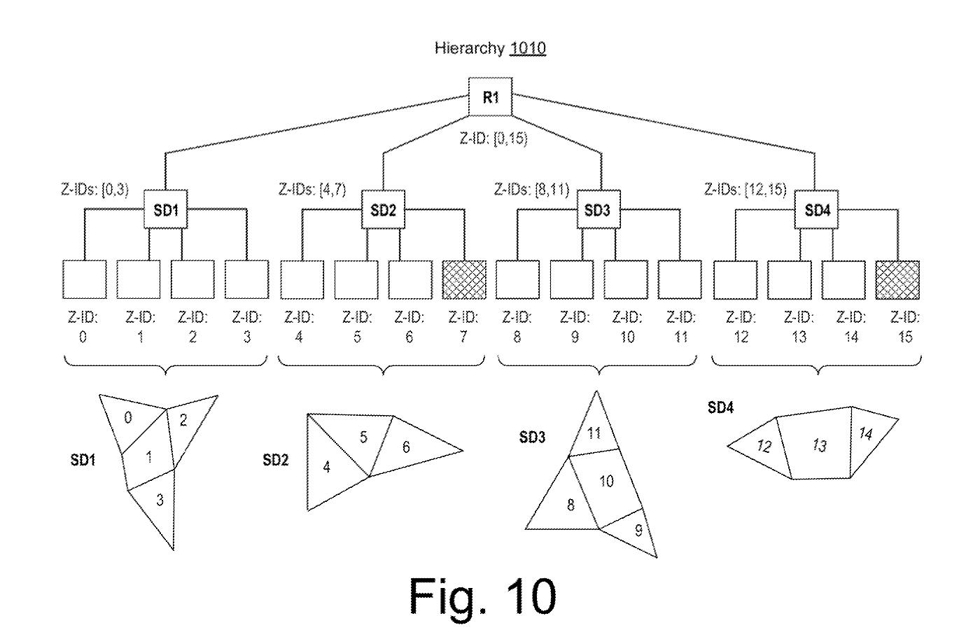

FIG. 10 shows an example of a hierarchy 1010 of the region R1, the subdomains SD1 to SD4 and the cells as indexed 0, 1, 2, 3, 4, 5, 6, 8, 9, 10, 11, 12, 13 and 14; noting that unused indices 7 and 15 can exist within the hierarchy (e.g., as associated with SD2 and SD4, which include three cells rather than four cells). As an example, the hierarchy 1010 may be a tree that includes levels that may be levels of detail (LoD).

As an example, partitioning may be performed according to one or more rules. For example, consider a “distributed” rule and/or a “concentrated” rule. As to a distributed rule, consider partitioning such that the fill, if any, is distributed (see, e.g., the fill indices 7 and 15 of the example hierarchy 1010 of FIG. 10). As to a concentrated rule, consider partitioning such that the “fill”, if any, is concentrated in a section of a hierarchy (e.g., a tree, etc.) that corresponds to higher node numbers as this may reduce size of a regular array that can store the data, which may, for example, reduce the amount of data that is ever loaded.

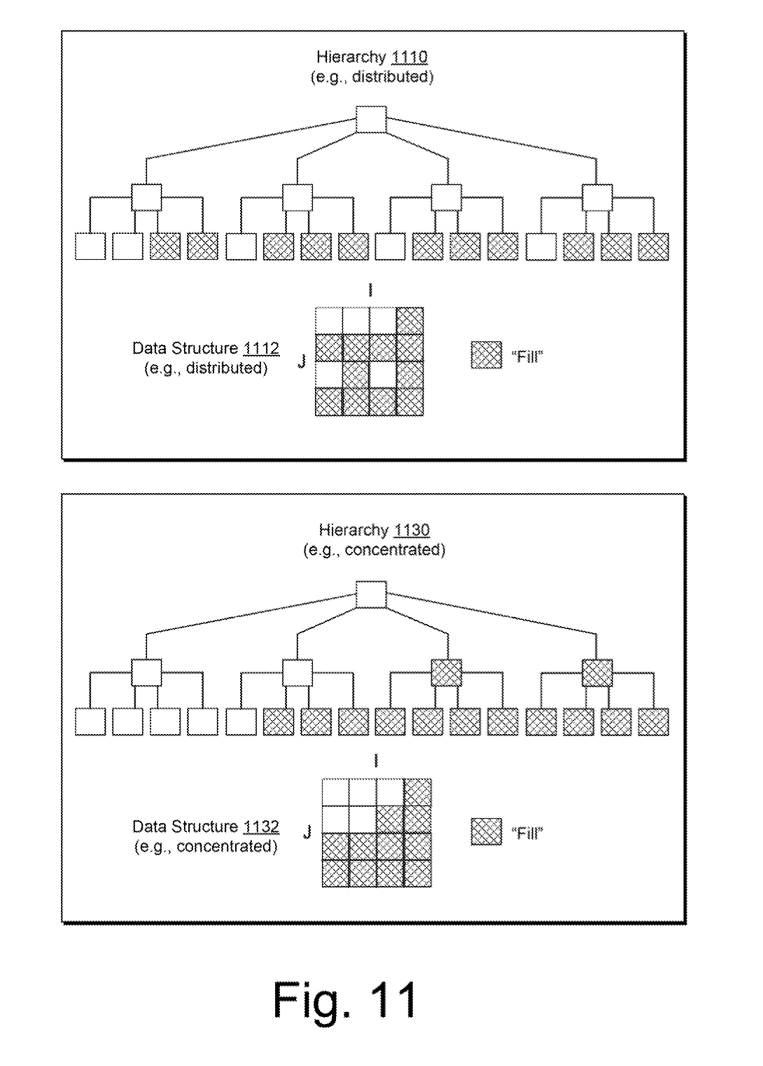

FIG. 11 shows an example hierarchy 1110 and an example hierarchy 1130 where the “fill” (of eleven cells) is distributed in the hierarchy 1110 and concentrated in the hierarchy 1130. As shown, the fill, where a subdomain may include fewer cells than a maximum cell number, allows for defining a data structure such as, for example, a data structure 1112 per the hierarchy 1110 and a data structure 1132 per the hierarchy 1130. As an example, a method may include implementing one or more rules as to partitioning with respect to how fill is organized. As an example, depending on one or more characteristics of a region, a property, etc., a rule may be selected. As an example, depending on one or more computation related parameters, a rule may be selected.

As an example, a method that may include “fill” nodes (e.g., or fill cells) may include omitting these from a physical file (e.g., by taking advantage of sparse functionality in an array (e.g., an ability not to explicitly define null elements). As an example, a method that may include “fill” nodes may include creating a structured array up to dimensions sufficient to hold “non-fill” nodes.

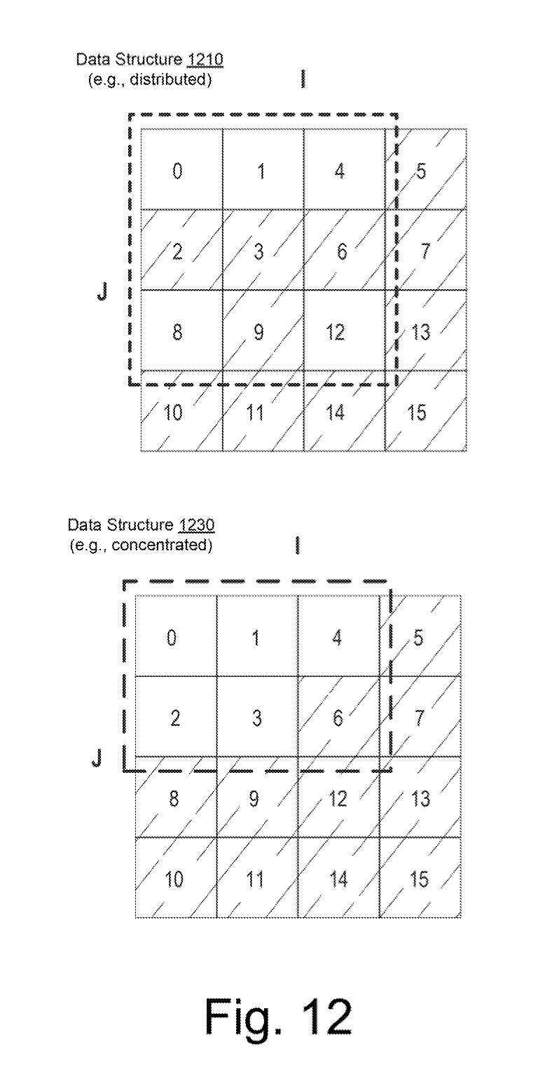

FIG. 12 shows an example data structure 1210 that corresponds to the sixteen cells of the hierarchy 1110 of FIG. 11 and an example data structure 1230 that corresponds to the sixteen cells of the hierarchy 1130 of FIG. 11. In the examples of FIG. 12, indices (e.g., I and J) may correspond to mathematical, computational, storage, etc. indices. As shown, for the data structure 1210, which corresponds to the hierarchy 1110 that applied a distributed rule, an array size of 3×3 (e.g., or nine entries) is sufficient; whereas, for the data structure 1230, which corresponds to the hierarchy 1130 that applied a concentrated rule, an array size of 2×3 (e.g., or 3×2) (e.g., or six entries) is sufficient. Thus, as mentioned, size of an array may be dependent on application of one or more rules that may address “fill” (e.g., unused indices, nodes, etc. of a hierarchical representation of an unstructured grid).

As an example, a method can include receiving an unstructured grid of a region with an existing ordering, a partitioning of the region into subdomains (e.g., in a recursive manner where each subdomain includes a number of cell that may be equal to or less than a cell number criterion), and space-filling curve ordering of cells therein (e.g., as an indexing process that may be suitable for mapping, etc.). As an example, a method can include generating a hierarchical representation of a region of an unstructured grid. In such an example, the hierarchical representation may be a tree (e.g., a tree structure) generated, for example, via recursive partitioning. In such an example, space-filling curve ordering may be implemented, for example, such that new cell indices (e.g., cell IDs) are contiguous for children of a node (e.g., a subdomain, etc.) in the tree. As an example, a method can include partitioning and/or indexing using one or more rules that pertain to fill (e.g., unused indices, unused nodes, etc.). Referring again to FIG. 11, the hierarchies 1110 and 1130 pertain to five cells that may be distributed (see, e.g., the hierarchy 1110) or concentrated (see, e.g., the hierarchy 1130). As shown, the hierarchy 1110 includes subdomains with “fill” distributed throughout the tree; whereas, the hierarchy 1130 includes subdomains with “fill” concentrated to a section of the tree. As mentioned, resulting locations of “fill” cells may be in a structured array in a manner that depends on one or more characteristics of a hierarchical representation (see, e.g., the data structures 1210 and 1230 of FIG. 12).

As an example, due to a regular structure of a tree, new numbering can be used to directly map the data back to a 2D square or 3D cube using a space-filling curve algorithm. As an example, a Z-order curve algorithm may be applied to an unstructured grid as to its initial indices to “linearize” the order of these indices. For example, as illustrated in FIG. 9, the region R1 includes cell indices 0 to 13, where sequential indices are not necessarily corresponding to adjacent cells. A Z-order curve algorithm may generate a vector of the indices from 0 to 13 that can be used for purposes of mapping to a data structure of indexed cells associated with subdomains.

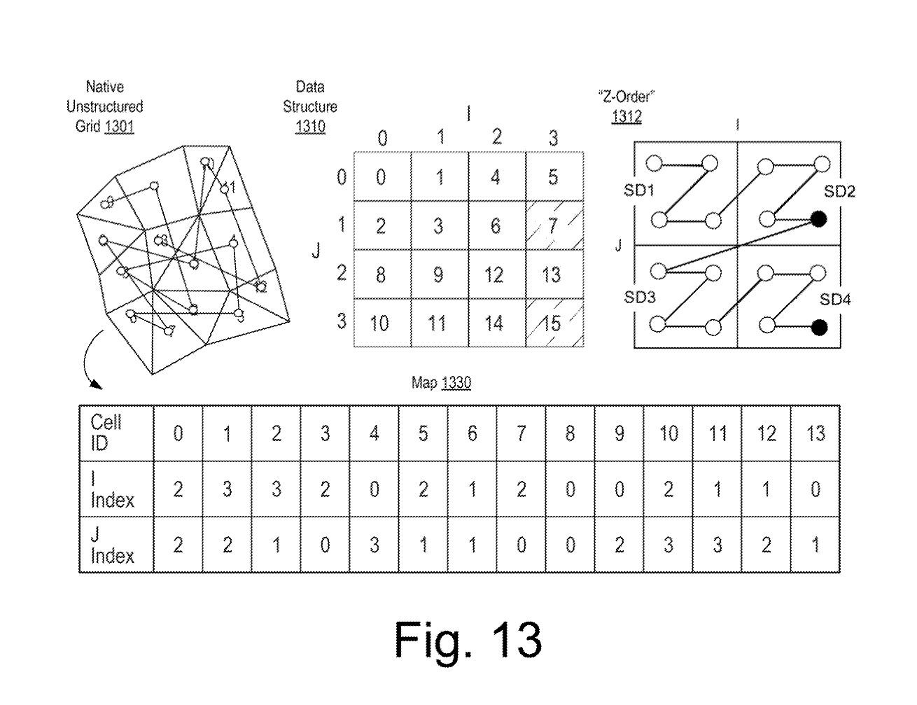

FIG. 13 shows an unstructured grid 1301 (see also of FIG. 9), an example of a data structure 1310 with a corresponding Z-order for subdomains and cells 1312 (e.g., a space-filling curve order), and an example of a map 1330. As shown, the data structure 1310 corresponds to the hierarchy 1010 of FIG. 10, which includes fill index 7 of subdomain SD2 and fill index 15 of subdomain SD4, and data structure indices I and J where I=0, 1, 2 and 3 and J=0, 1, 2 and 3. For example, fill may be indexed at a particular position or positions (e.g., consider an end position and proceeding from the end inward where more than one fill exists). The map 1330 includes cell IDs from 0 to 13, which correspond to the original ordering of the region R1 as shown in FIG. 9 and the unstructured grid 1301. As illustrated in FIG. 13, the cell IDs from 0 to 13 may be ordered according to a Z-order curve algorithm, for example, for purposes of mapping, map generation, etc. As shown in the example of FIG. 13, while the data structure 1310 includes sixteen entries, the map 1330 includes fourteen entries as the region R1 includes fourteen cells.

As an example, a method can include performing a transformation from a space-filling curve order ID to I, J and K indices (e.g., of a data structure, which itself may be “ordered”). In such an example, a map may be generated (e.g., and stored in memory) or, for example, a transformation may be performed in an on-demand manner (e.g., “on the fly”, responsive to a call, etc.). As an example, a map may reference used indices and not unused indices, which may reduce map size. As an example, for a three-dimensional map, I, J and K indices may be used. As an example, where a map includes time as a dimension, an additional index may be used (e.g., for a series of maps for individual times). A data structure may include one or more values per index n-tuple (e.g., index pair, index triple, index quadruple). For example, a cell may be associated with a property value, property values, etc. A map may include dimensions sufficient to map transformed indexed cells of a hierarchical representation of an unstructured grid to original indexed cells of the unstructured grid.

As an example, once cells have been mapped to an structured array, level of details versions of properties may be calculated directly by considering averages recursively, for example, over 2×2(×2) blocks of data (e.g., as may depend on a cell number criterion). In such an example, blocks of data may correspond directly to recursive partitions used to generate the ordering and hence partitioning criteria can have an effect on generation of level of detail averages (e.g., or other calculated values that may be based on a plurality of cells).

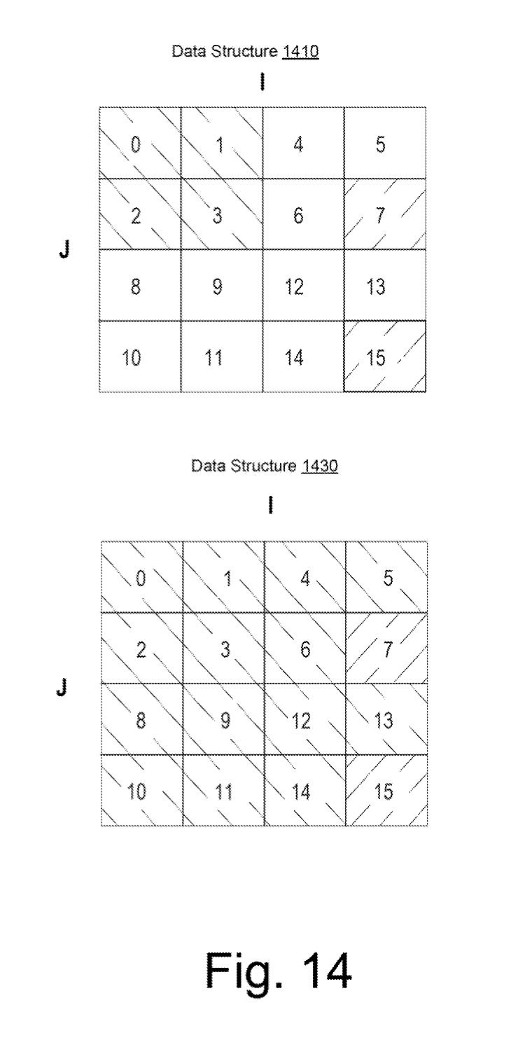

FIG. 14 shows examples of cell index groupings 1410 and 1430 with respect to a data structure corresponding to the hierarchical representation of cells of the unstructured grid of region R1 of FIG. 9. The grouping 1410 includes indices 0, 1, 2 and 3 of the subdomain SD1, which corresponds to original ordering 8, 3, 13 and 6 of the region R1. The grouping 1410 may be used to average values of indexed cells 0, 1, 2 and 3 to provide a value for the subdomain SD1. While an average is mentioned, one or more other types of calculations may be performed. For example, consider one or more statistical computations where, for example, a mean and a standard deviation may be calculated for a subdomain. In the grouping 1430, the region R1 is represented by the cells, which include the fill indices 7 and 15. As illustrated by the groupings 1410 and 1430, cells corresponding to recursive partitions may naturally form regular blocks in a structured array over which level of detail property averages may be computed (e.g., or one or more other values).

As shown in FIG. 14, depending on the level of detail, one or more fill cells may participate in a level of detail computation (e.g., averaging, etc.). In such an example, a fill cell may be assigned a value that may, for example, not alter the value that would have been created if a computation was taken without the fill cell. As an example, a fill cell may be assigned an extreme value, for example, to highlight subdomains that include one or more fill cells. As an example, for a volume weighted average (e.g., or other volume weighted computation), a method may include assigning a negligible volume (e.g., a zero volume) to a fill cell (e.g., or fill cells).

As an example, a level of detail property computation may provide a low resolution version of a property; however, they may still be applied to a full resolution mesh. As an example, results of calculations that are made for at a particular level of detail may be used to expedite calculations at another level of detail. For example, where calculations are performed at a subdomain level (e.g., to average cells), results of those calculations may expedite calculations to be performed at a region level. For example, where cell property values of cells of each of the subdomains SD1 to SD4 are averaged to provide individual average values for each of the subdomains SD1 to SD4, those values may be used to provide an individual average value for the region R1.

As mentioned, the level of detail properties can provide a low resolution version of a property and they can still be applied to a full resolution mesh. To find the indices into the level of detail arrays associated with a cell in the full resolution mesh then the mapping from Cell ID to structure array indices is first used and then resulting indices are divided by 2 to the power of the level of detail being displayed, for example, with 0 being full resolution, and a higher value being progressively more coarsened.

As an example, a method can include partitioning properties separately, for example, to minimize property value variance within cells to be averaged. As an example, computations may calculate values other than averages. As an example, statistics may be computed for a plurality of cells and represented as values where a visualization rendered to a display may illustrate how the values vary over a region or regions.

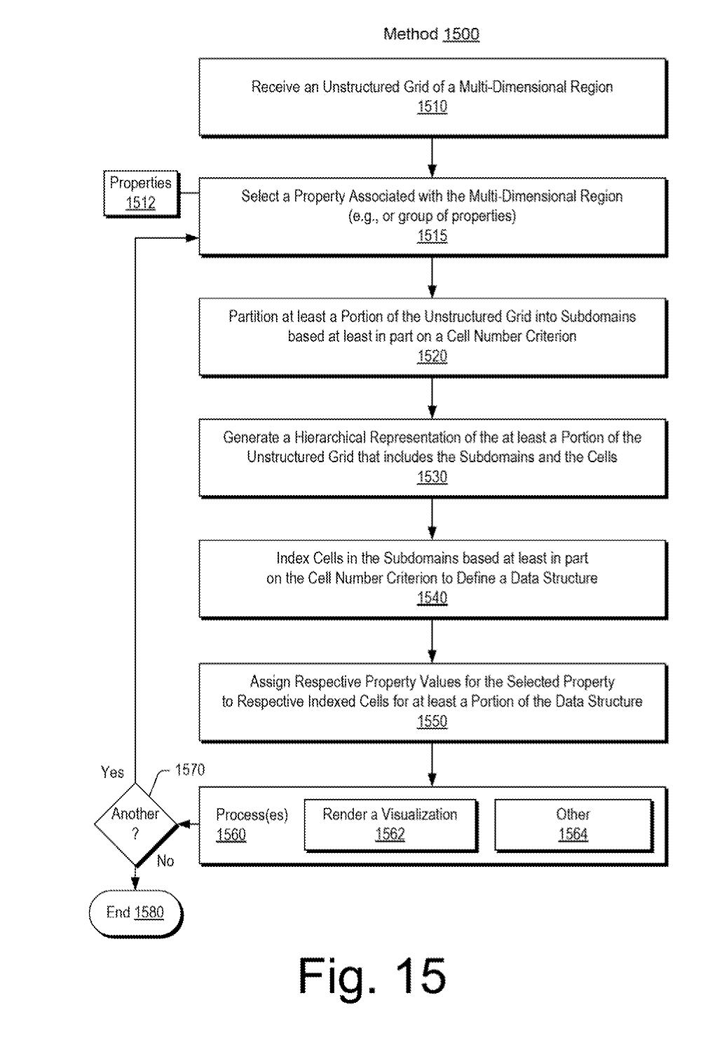

FIG. 15 shows an example of a method 1500 that includes a reception block 1510 for receiving an unstructured grid of a multi-dimensional region; a properties block 1512 that can provide a plurality of properties; a selection block 1515 for selecting a property associated with the multi-dimensional region (e.g., which may optionally select more than one of the properties of the properties block 1512); a partition block 1520 for partitioning at least a portion of the unstructured grid into subdomains based at least in part on a cell number criterion; a generation block 1530 for generating a hierarchical representation of the at least a portion of the unstructured grid that includes the subdomains and the indexed cells; an index block 1540 for indexing cells in the subdomains based at least in part on the cell number criterion to define a data structure; an assignment block 1550 for assigning respective property values for the selected property to respective indexed cells for at least a portion of the data structure; and, for example, a process block 1660 may include one or more sub-blocks such as a render block 1562 for rendering a visualization of at least some of the property values of the respective indexed cells to a display and/or an other process block 1564 (e.g., extraction, data transfer, analysis, etc.). As an example, the method 1500 may include a decision block 1570 for deciding whether to select another property, another group of properties, etc. Where a decision is made to select at least one other property, the method 1500 may continue at the selection block 1515, otherwise, for example, the method 1500 may end at the termination block 1580 or take one or more other actions. As to other actions, for example, consider assigning respective property values per the block 1550 at a different level of detail of the generated hierarchical representation. As another example, consider assigning respective statistical values, for example, based on a statistical computation for a plurality of cells in a subdomain, a region, etc.

As an example, medium or media may be configured with instructions to allow for, at least in part, performance of various actions of the method 1500. As an example, a computer-readable medium (CRM) may be a computer-readable storage medium that is non-transitory and that is not a carrier wave. As an example, one or more blocks may be in the form of a module such as, for example, one of the modules 270 of the system 250 of FIG. 2.

As an example, a method may aim to implement a common partitioning for individual properties in a group of properties. As an example, a method may include partitioning according to a partitioning criterion or criteria. For example, a method may include partitioning along low transmissibility edges so that features such as sealing faults do not have properties averaged over them.

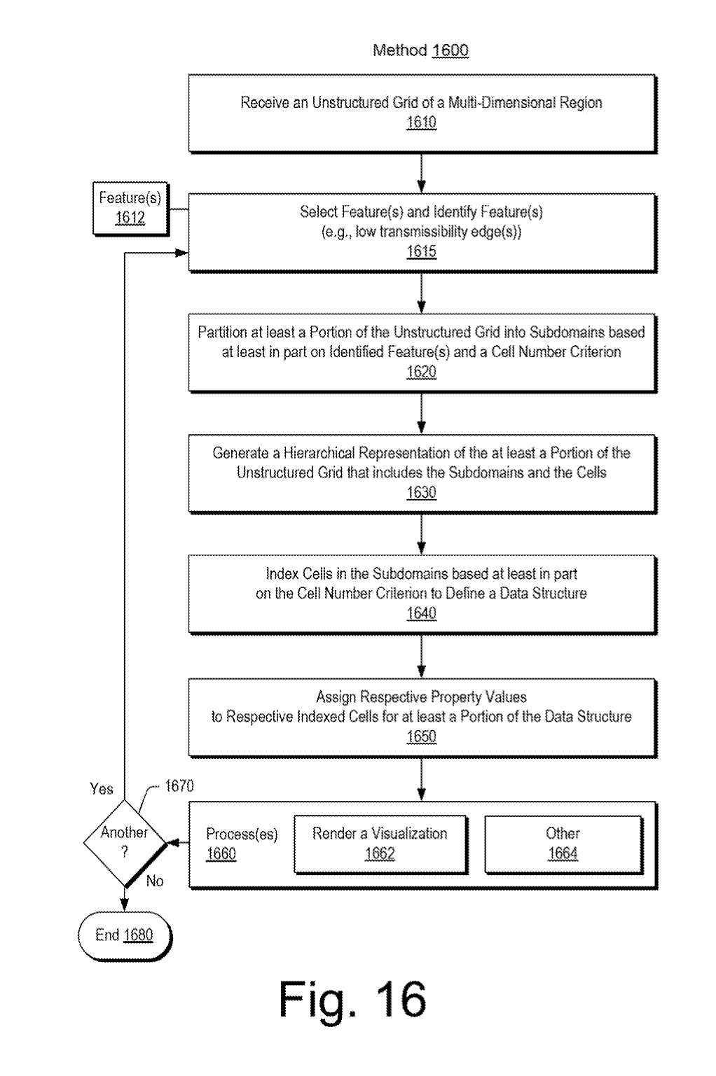

FIG. 16 shows an example of a method 1600 that includes a reception block 1610 for receiving an unstructured grid of a multi-dimensional region; a feature(s) block 1612 that can provide a feature or features for selection; a selection and identification block 1615 for selecting and identifying one or more selected features (e.g., as a feature criterion or feature criteria); a partition block 1620 for partitioning at least a portion of the unstructured grid into subdomains based at least in part on the identified feature(s) and at least in part on a cell number criterion; a generation block 1630 for generating a hierarchical representation of the at least a portion of the unstructured grid that includes the subdomains and the cells (e.g., where the hierarchical representation includes at least one level of detail that corresponds to the feature-based partitioning); an index block 1640 for indexing cells in the subdomains based at least in part on the cell number criterion to define a data structure; an assignment block 1650 for assigning respective property values to respective indexed cells for at least a portion of the data structure; and, for example, a process block 1660 that may include one or more sub-blocks such as a render block 1662 for rendering a visualization of at least some of the property values of the respective indexed cells to a display and/or an other process block 1664 (e.g., extraction, data transfer, analysis, etc.).

As an example, the method 1600 may include a decision block 1670 for deciding whether to select another feature, another group of features, etc. as a criterion or criteria to perform partitioning per the partition block 1620. Where a decision is made to select at least one other feature, the method 1600 may continue at the selection and identification block 1615, otherwise, for example, the method 1600 may end at the termination block 1680 or take one or more other actions. As to other actions, for example, consider assigning respective property values per the block 1650 at a different level of detail of the generated hierarchical representation. As another example, consider assigning respective statistical values, for example, based on a statistical computation for a plurality of cells in a subdomain, a region, etc.

As an example, medium or media may be configured with instructions to allow for, at least in part, performance of various actions of the method 1600. As an example, a computer-readable medium (CRM) may be a computer-readable storage medium that is non-transitory and that is not a carrier wave. As an example, one or more blocks may be in the form of a module such as, for example, one of the modules 270 of the system 250 of FIG. 2.

As an example, a method can include using parallel processing. For example, consider a parallel simulator (e.g., a simulator with parallel processing circuitry) where parallel partitioning may be incorporated into partitioning used to generate Z-order curve(s). In such an example, a number of parallel partitions may be selected independently from a constraint to map a grid to a regular array. In such an example, a result may include a fixed number of nodes (e.g., the parallel partitions) at some level within a hierarchical representation (e.g., a tree structure with nodes and branches). For example, as a result an optimal partitioning as shown in concentrated hierarchy 1130 of FIG. 11 may not necessarily be attainable as such a hierarchy applies a concentration rule that may operate over a number of nodes at each level of the hierarchy. As an example, a method may act to ensure that, within each parallel partition, one or more fill cells (e.g., where a cell number is less than a cell number criterion) are located in one section of the hierarchy (e.g., as in the hierarchy 1130 of FIG. 11) and, for example, the method may implement a file system supporting sparsity such that if there are large levels of fill these can be left out of storage (e.g., not explicitly stored in a file in the file system).

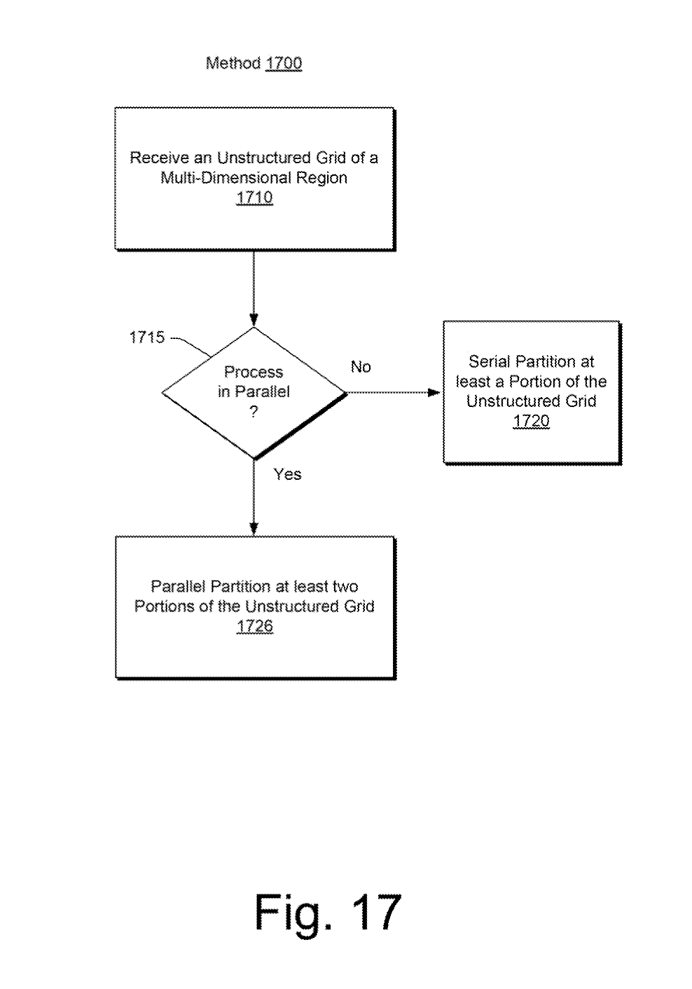

FIG. 17 shows an example of a method 1700 that includes a reception block 1710 for receiving an unstructured grid of a multi-dimensional region, a decision block 1715 for deciding whether to process in parallel, a serial partitioning block 1720 for serially partitioning at least a portion of the unstructured grid and a parallel partitioning block for partitioning at least two portions of the unstructured grid in parallel. As an example, the decision block 1715 may operate as a background decision making process, for example, via an underlying operating system or operating systems. As an example, a graphical user interface may be rendered to a display by a computing device or computing system where an option exists to process in parallel or to process in serial. As an example, an option may exist to process at least in part in parallel and at least in part in serial. As an example, parallel processing can perform at least a portion of a method in parallel (e.g., consider the method 300 of FIG. 3, etc.).

As an example, a computing system may include a hypervisor that may operate one or more virtual machines that can be implemented in parallel to perform parallel processing. As an example, a hypervisor may be software, firmware and/or hardware that can create virtual machines. A computing device or system on which a hypervisor is running one or more virtual machines may be defined as a host machine where, for example, each virtual machine may be referred to as a guest machine.

As an example, medium or media may be configured with instructions to allow for, at least in part, performance of various actions of the method 1700. As an example, a computer-readable medium (CRM) may be a computer-readable storage medium that is non-transitory and that is not a carrier wave. As an example, one or more blocks may be in the form of a module such as, for example, one of the modules 270 of the system 250 of FIG. 2.

As an example, for grids that include one or more local grid refinements (LGRs), one or more options may exist as to handling of such one or more LGRs. One option can be treating LGR cells like other cells in a grid. In such an example, as a result, the LGR cells may belong to differing partitions higher up a hierarchical structure (e.g., a tree, etc.) and therefore the cells' values might not be particularly close in a data structure (e.g., an array), and hence in a physical file stored in memory. As an example, an option may be to handle LGR cells such that they intentionally form a single partition at some level in a hierarchy (e.g., a tree), for example, to ensure that the LGR cells are contiguous in a space-filling curve order (e.g., Z-order, etc.) and hence close in a data structure (e.g., an array) as may be stored as a physical file in memory. As an example, a method may include performing a separate mapping for LGR cell IDs to data structure indices, for example, to help ensure that LGR cell values can be accessed efficiently, for example, independently from a global grid. In such an example, this can result in one mapping (e.g., akin to the concentrated hierarchy 1130 of FIG. 11) for global cells and multiple mappings for individual LGRs where, for example, data may be stored in a single structured array.

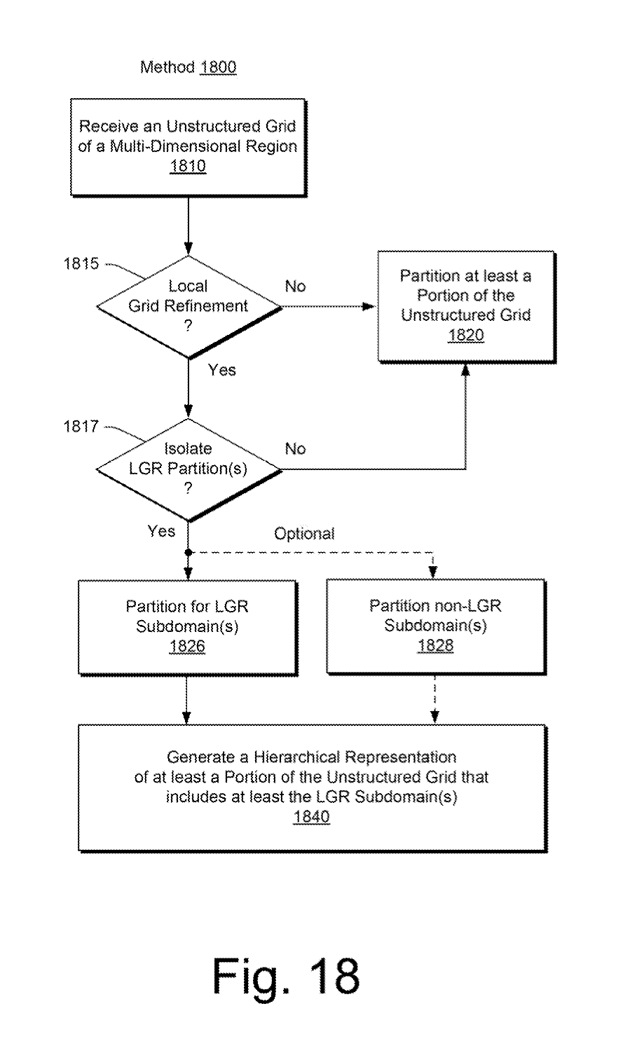

FIG. 18 shows an example of a method 1800 that includes a reception block 1810 for receiving an unstructured grid of a multi-dimensional region, a decision block 1815 for deciding whether local grid refinement (LGR) exists, a decision block 1817 for deciding whether to isolate one or more LGR partitions where one or more LGRs do exist, a partition block 1820 for partitioning at least a portion of the unstructured grid where a decision is made that one or more LGRs do not exist or where a decision is made to not isolate one or more LGRs as partitions, a partition block 1826 for partitioning at least a portion of the unstructured grid into one or more LGR subdomains and a generation block 1840 for generating a hierarchical representation of at least a portion of the unstructured grid that includes at least the one or more LGR subdomains and corresponding cells.

As shown in FIG. 18, the method 1800 may optionally include a partition block 1828 for partitioning one or more non-LGR subdomains and continuing to the generation block 1840 where a hierarchical representation may be generated that includes cells in one or more LGR subdomains and cells in one or more non-LGR subdomains.

As an example, medium or media may be configured with instructions to allow for, at least in part, performance of various actions of the method 1800. As an example, a computer-readable medium (CRM) may be a computer-readable storage medium that is non-transitory and that is not a carrier wave. As an example, one or more blocks may be in the form of a module such as, for example, one of the modules 270 of the system 250 of FIG. 2.

As an example, for time-varying properties (e.g., and/or for a time varying grid), a method may employ, for example, a dimensional array that includes a time dimension (e.g., a three-dimensional array for a two-dimensional region, a four-dimensional array for a three-dimensional region, etc.). As an example, a method may include stacking data (e.g., organizing data) along a dimension in an array (e.g., with respect to time). In such an example, if the data are stacked then a certain amount of space may be left between each instance, for example, to help ensure that LoD versions of properties do not start to average values from two adjacent instances. As an example, a method may include capping a level of detail hierarchy and ensuring that a corresponding degree of separation between adjacent instances. As an example, having multiple instances of data within a single array may provide benefits, for example, such an approach may facilitate consuming applications to pre-fetch data for subsequent time steps from other parts of the array.

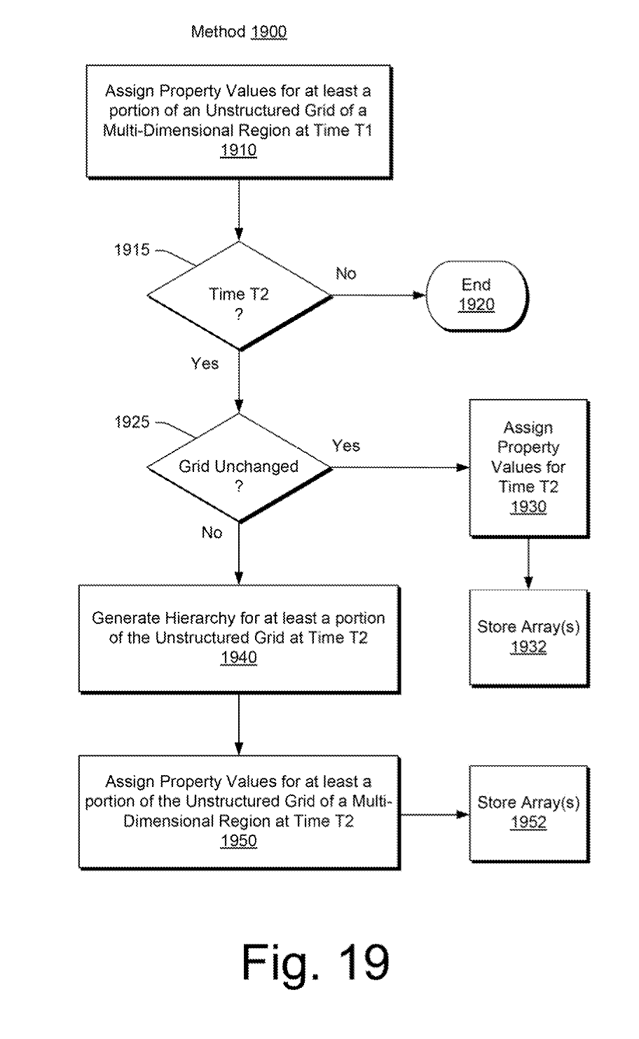

FIG. 19 shows an example of a method 1900 that includes a reception block 1910 for receiving an unstructured grid of a multi-dimensional region at a time T1, a decision block 1915 for deciding whether to consider a time T2, a termination block 1920 for terminating the method 1900 where a decision is made to not consider a time T2, and a decision block 1925 for deciding whether the grid is different at time T2 where time T2 is to be considered.

The method 1900 of FIG. 19 includes two branches where one of the branches is followed based on a decision of the decision block 1925. Where an unstructured grid remains unchanged at time T2, the method 1900 continues at an assignment block 1930 for assigning property values for time T2 (e.g., or other values as may be desired). The method 1900 may then store such values in a data structure (e.g., an array or arrays) per a storage block 1932. As to the other branch, where an unstructured grid is changed, the method 1900 can continue to a generation block 1940 for generating a hierarchy for at least a portion of the changed unstructured grid at time T2, an assignment block 1950 for assigning property values for a least a portion of the unstructured grid of a multi-dimensional region at time T2 and a storage block 1952 for storing values to a data structure in memory (e.g., storing one or more arrays in memory).

As an example, a change to a grid may include introduction of cells via, for example, local grid refinement. As an example, a change to a grid may include movement of one or more cell boundaries such that a new partitioning may represent better the grid that a partitioning for a prior time. For example, consider movement of a fault, movement of fluid, etc. As an example, where one or more features move and/or become more refined via introduction of cells in a grid, a method may include time-based partitioning such that individual times may be associated with individual partitions (e.g., and hierarchies). As an example, depending on the type of movement, some “overlap” may exist and a data structure at one time may be suitable for use at least in part at another time (e.g., consider a “delta” data structure that represents a changed portion of a grid).

As an example, medium or media may be configured with instructions to allow for, at least in part, performance of various actions of the method 1900. As an example, a computer-readable medium (CRM) may be a computer-readable storage medium that is non-transitory and that is not a carrier wave. As an example, one or more blocks may be in the form of a module such as, for example, one of the modules 270 of the system 250 of FIG. 2.

As an example, a method can include filtering and/or sorting of information as may be associated with subdomains, cells, etc. represented by a hierarchy (e.g., a tree, etc.). As an example, consider a method that includes filtering of property values based at least in part on minimum and maximum values of the property at one or more individual levels of detail, which may, for example, be additionally recorded such that if a node in a hierarchy (e.g., a tree, etc.) includes minimum and maximum values that do not overlap with the range of the filter such a condition can imply that higher resolution level of detail (LoD) nodes will lie outside the range of the filter. In such a manner, an efficient hierarchical search may be employed that may, for example, alleviate having to loading property values at one or more levels of detail (e.g., more refined levels of detail). As an example, as values at one or more levels of detail may be approximations as to values of a full resolution grid, data transfer, storage and/or computation demands may optionally be reduced by, for example, reduction of bit length. For example, 32 bit values may be reduced to 16 bit values or 8 bit values, 16 bit values may be reduced to 8 bit values, etc. As an example, a method may include mapping values to lower bit length values.

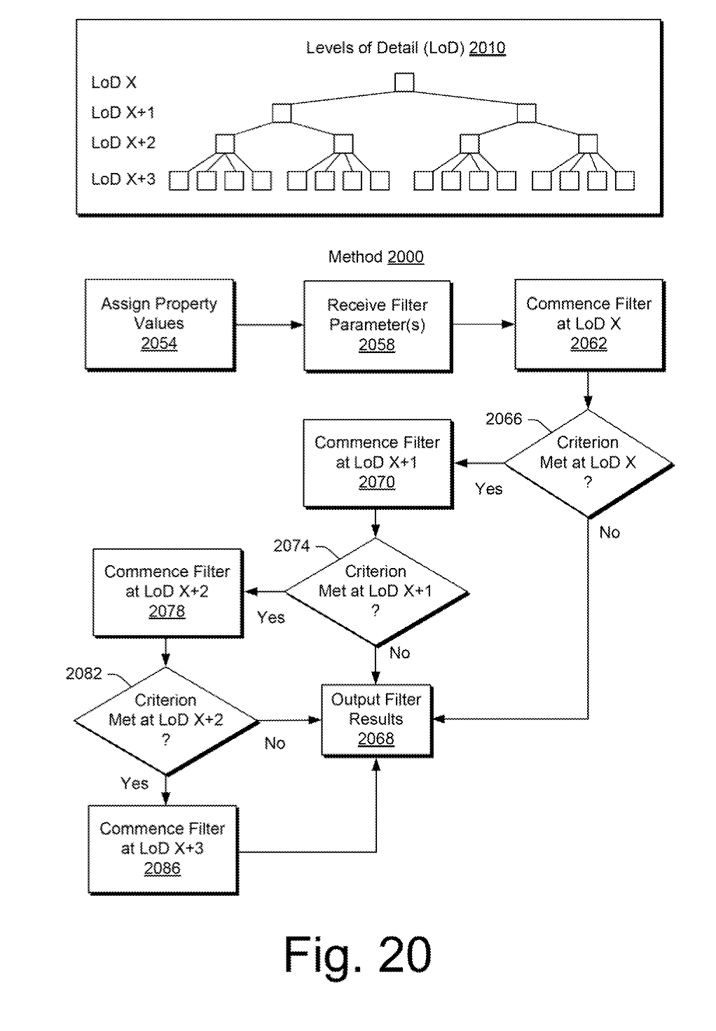

FIG. 20 shows an example of method 2000 and an example of a hierarchy 2010 that includes levels of detail (LoD) such as LoD X, LoD X+1, LoD X+2 and LoD X+3. In FIG. 20, the method 2000 may be described with respect to the example hierarchy 2010.

The method 2000 includes an assignment block 2054 for assigning property values (e.g., or other values, as desired), a reception block 2058 for receiving one or more filter parameters (e.g., and/or sorting parameters, etc.), a commencement block 2062 for commencing filtering at the LoD X, a decision block 2066 for deciding whether the filter criterion or criteria are met at LoD X, if not, the method 2000 continues to an output block 2068 for outputting filter results. However, if the one or more filter criteria (e.g., per the reception block 2058) are met at LoD X, the method 2000 continues at a commencement block 2070 for filtering at LoD X+1 and then a decision block 2074 for deciding whether the filter criterion or criteria are met at LoD X+1, if not, the method 2000 continues to an output block 2068 for outputting filter results. However, if the one or more filter criteria (e.g., per the reception block 2058) are met at LoD X+1, the method 2000 continues at a commencement block 2078 for filtering at LoD X+2 and then a decision block 2082 for deciding whether the filter criterion or criteria are met at LoD X+2, if not, the method 2000 continues to an output block 2068 for outputting filter results. However, if the one or more filter criteria (e.g., per the reception block 2058) are met at LoD X+2, the method 2000 continues at a commencement block 2086 for filtering at LoD X+3 and then continues to an output block 2068 for outputting filter results. In the example of FIG. 20, the method 2000 as operating with respect to LoD X+1 to LoD X+3 considers individual “nodes” of the hierarchy 2010, thus, the decision blocks 2074 and 2082 can include loops within that consider nodes of the hierarchy 2010 at the respective LoDs LoD X+1 and LoD X+2.

As an example, medium or media may be configured with instructions to allow for, at least in part, performance of various actions of the method 2000. As an example, a computer-readable medium (CRM) may be a computer-readable storage medium that is non-transitory and that is not a carrier wave. As an example, one or more blocks may be in the form of a module such as, for example, one of the modules 270 of the system 250 of FIG. 2.

As an example, a method can include storing values (e.g., property values) associated with a hierarchy in a 1D array, for example, using a space-filling curve ordering directly (e.g., consider Z-order curve ordering, etc.). In such an example, where a level of detail averaging is desired to work on a constant number of cells (e.g., 4, 8, etc.), then fill cells, if present, may still be inserted into the 1D array. As an example, a method may include retaining fill cells to make mapping between a space-filling curve order ID for a root LoD (e.g., LoD 0) and one or more higher levels facile. As an example, a method may include, where level of detail averaging is implemented over a varying number of cells, recording start and end indices of each LoD at each level so that, for a given cell ID, a space-filling curve order ID may be looked-up in a mapping and then the ID at a given LoD.

As an example, a method can include receiving an unstructured grid of a multi-dimensional region; partitioning at least a portion of the unstructured grid into subdomains; generating a hierarchical representation of the at least a portion of the unstructured grid that includes the subdomains and the cells; indexing cells in the subdomains based at least in part on a cell number criterion to define a data structure; and assigning respective property values to respective indexed cells for at least a portion of the data structure. As an example, such a method may include rendering a visualization of at least some of the property values of respective indexed cells to a display. As an example, a data structure may be defined to include fill. For example, fill may be a result of a subdomain including fewer cells than specified by a cell number criterion, which may be a maximum cell number per subdomain. For example, where a maximum cell number per subdomain is four, where a subdomain includes three cells, the data structure can include a block for those three cells and a fill block. In such a manner, a data structure may be regular even though a number of subdomains of a region of an unstructured grid are not (e.g., a number of cells in at least one subdomain differs from a number of cells in another subdomain of a region).

As an example, a method can include a cell number criterion that specifies a maximum cell number per subdomain. In such an example, a data structure can be defined to include fill that accounts for at least one of a plurality of subdomains in a region of an unstructured grid including a number of cells that is less than the maximum cell number per subdomain.

As an example, a method can include indexing based at least in part on a space-filling curve ordering technique (e.g., a Z-order curve technique, etc.). For example, a hierarchy such as a tree may be Z-ordered to form an array such that nodes of the tree that represent cells (e.g., or fill) may be organized as indexed entries of an array. As an example, a method can include generating a map based at least in part on a space-filling curve ordering technique (e.g., a Z-order curve technique, etc.).

As an example, a method can include recursive partitioning where each recursion generates a level of detail. As an example, a subdomain may include cells, which may be further partitioned into subdomains that include cells. As an example, a most refined level of detail may include a plurality of individual cells.

As an example, a method can include generating a hierarchical representation that includes levels of detail (LoDs). As an example, partitioning may include recursive partitioning that can iteratively generate levels of detail (LoD). As an example, partitioning may be performed at least in part using parallel processing.

As an example, a method can include identifying at least one feature of a multi-dimensional region and partitioning at least a portion of an unstructured grid for the multi-dimensional region into subdomains based at least in part on the at least one identified feature. In such an example, the at least one feature may include a low transmissibility feature. As an example, a low transmissibility feature may be a fault such as, for example, a sealed fault.

As an example, a method can include parallel processing, for example, for partitioning a region into subdomains and/or indexing cells of subdomains.

As an example, a method can include generating a subdomain for a portion of an unstructured grid that includes a locally refined grid (LGR). As an example, an LGR may be to more accurately model a feature. In such an example, a feature may be, for example, a low transmissibility feature.

As an example, property values may correspond to a time and a method may include repeating at least part of a process that includes assigning for property values to assign property values that correspond to a different time.

As an example, a method can include filtering at least a portion of property values based at least in part on at least one filter criterion and at least in part on a hierarchical representation of an unstructured grid of a multi-dimensional region.

As an example, a system can include a processor; memory operatively coupled to the processor; and modules that include processor-executable instructions stored in the memory to instruct the system where the instructions include instructions to receive an unstructured grid of a multi-dimensional region; partition at least a portion of the unstructured grid into subdomains; generate a hierarchical representation of the at least a portion of the unstructured grid that includes the subdomains and the cells; index cells in the subdomains based at least in part on a cell number criterion to define a data structure; and assign respective property values to respective indexed cells for at least a portion of the data structure. In such an example, the instructions to index cells can include instructions to index cells at least in part via a space-filling curve technique (e.g., a Z-order curve technique, etc.).

As an example, a system can include instructions to identify at least one feature of a multi-dimensional region and to partition at least a portion of an unstructured grid of the multi-dimensional region into subdomains based at least in part on the at least one identified feature.

As an example, a system can include instructions to filter at least a portion of property values based at least in part on at least one filter criterion and at least in part on hierarchical representation of an unstructured grid of a multi-dimensional region.

As an example, a computer-readable storage medium can include computer-executable instructions to instruct a computer where the instructions include instructions to: receive an unstructured grid of a multi-dimensional region; partition at least a portion of the unstructured grid into subdomains; generate a hierarchical representation of the at least a portion of the unstructured grid that includes the subdomains and the cells; index cells in the subdomains based at least in part on a cell number criterion to define a data structure; and assign respective property values to respective indexed cells for at least a portion of the data structure. In such an example, instructions to index cells can include instructions to index cells at least in part via a space-filling curve technique (e.g., a Z-order curve technique, etc.).

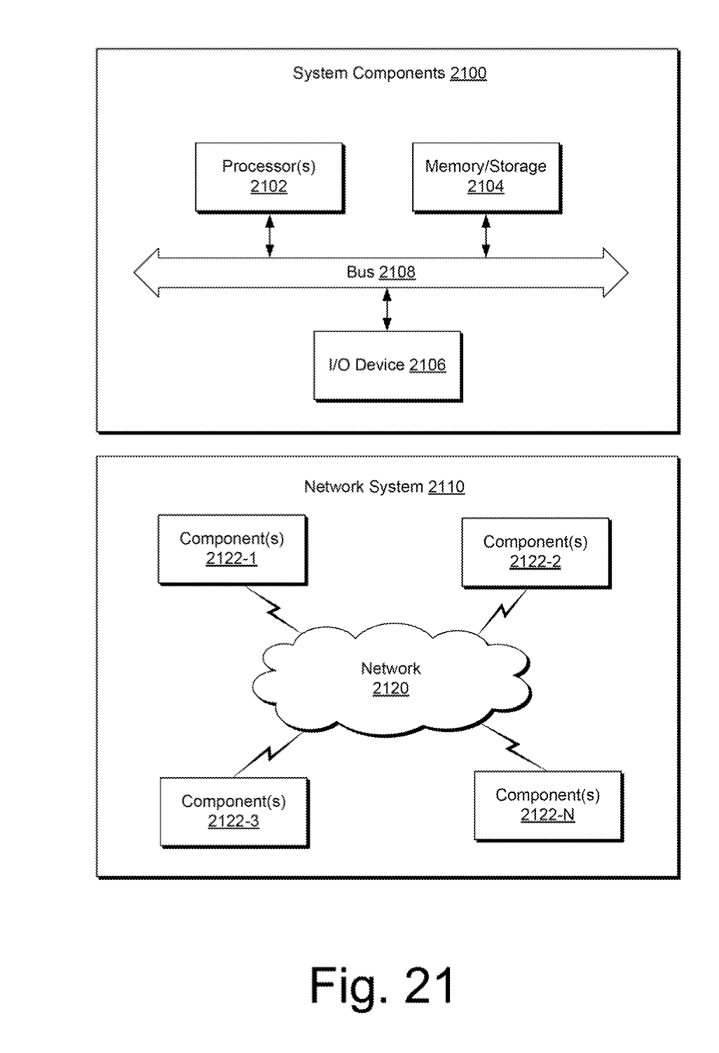

FIG. 21 shows components of an example of a computing system 2100 and an example of a networked system 2110. The system 2100 includes one or more processors 2102, memory and/or storage components 2104, one or more input and/or output devices 2106 and a bus 2108. In an example embodiment, instructions may be stored in one or more computer-readable media (e.g., memory/storage components 2104). Such instructions may be read by one or more processors (e.g., the processor(s) 2102) via a communication bus (e.g., the bus 2108), which may be wired or wireless. The one or more processors may execute such instructions to implement (wholly or in part) one or more attributes (e.g., as part of a method). A user may view output from and interact with a process via an I/O device (e.g., the device 2106). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2110. The network system 2110 includes components 2122-1, 2122-2, 2122-3, . . . 2122-N. For example, the components 2122-1 may include the processor(s) 2102 while the component(s) 2122-3 may include memory accessible by the processor(s) 2102. Further, the component(s) 2102-2 may include an I/O device for display and optionally interaction with a method. As an example, one or more of the components 2122-1, 2122-2, 2122-3, . . . 2122-N may be or include a display. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving an unstructured grid of a multi-dimensional region;
partitioning at least a portion of the unstructured grid into subdomains based at least in part on a cell number criterion;
generating a hierarchical representation of the at least a portion of the unstructured grid that comprises the subdomains and the cells;
indexing cells in the subdomains based at least in part on the cell number criterion to define a data structure; and
assigning respective property values to respective indexed cells for at least a portion of the data structure.

2. The method of claim 1 further comprising rendering a visualization of at least some of the property values of respective indexed cells to a display.

3. The method of claim 1 wherein the indexing comprises space-filling via a space-filling curve technique.

4. The method of claim 1 wherein the cell number criterion comprises a maximum cell number per subdomain and wherein the data structure is defined to comprise fill that accounts for at least one of the subdomains including a number of cells that is less than the maximum cell number per subdomain.

5. The method of claim 1 wherein the partitioning comprises recursive partitioning wherein each recursion generates a level of detail.

6. The method of claim 1 further comprising identifying at least one feature of the multi-dimensional region and partitioning the at least a portion of the unstructured grid into subdomains based at least in part on the at least one identified feature.

7. The method of claim 6 wherein the at least one feature comprises a low transmissibility feature.

8. The method of claim 1 wherein the indexing comprises parallel processing of a plurality of the subdomains.

9. The method of claim 1 wherein the partitioning comprises generating a subdomain for a portion of the unstructured grid that comprises a locally refined grid.

10. The method of claim 1 wherein the property values correspond to a time and further comprising repeating at least the assigning for property values that correspond to a different time.

11. The method of claim 1 further comprising filtering at least a portion of the property values based at least in part on at least one filter criterion and at least in part on the hierarchical representation.

15. A system comprising:
a processor;
memory operatively coupled to the processor; and
one or more modules that comprise processor-executable instructions stored in the memory to instruct the system, the instructions comprising instructions to
receive an unstructured grid of a multi-dimensional region;
partition at least a portion of the unstructured grid into subdomains based at least in part on a cell number criterion;
generate a hierarchical representation of the at least a portion of the unstructured grid that comprises the subdomains and the cells;
index cells in the subdomains based at least in part on the cell number criterion to define a data structure; and
assign respective property values to respective indexed cells for at least a portion of the data structure.

16. The system of claim 15 wherein the instructions to index cells comprise instructions to index cells at least in part via a space-filling curve technique.

17. The system of claim 15 further comprising instructions to identify at least one feature of the multi-dimensional region and to partition the at least a portion of the unstructured grid into subdomains based at least in part on the at least one identified feature.

18. The system of claim 15 further comprising instructions to filter at least a portion of the property values based at least in part on at least one filter criterion and at least in part on the hierarchical representation.

19. One or more computer-readable storage media comprising computer-executable instructions to instruct a computer, the instructions comprising instructions to:
receive an unstructured grid of a multi-dimensional region;
partition at least a portion of the unstructured grid into subdomains based at least in part on a cell number criterion;
generate a hierarchical representation of the at least a portion of the unstructured grid that comprises the subdomains and the cells;
index cells in the subdomains based at least in part on the cell number criterion to define a data structure; and
assign respective property values to respective indexed cells for at least a portion of the data structure.

20. The one or more computer-readable storage media of claim 19 wherein the instructions to index cells comprise instructions to index cells at least in part via a space-filling via a space-filling curve technique.
